(19) United States
(12) Patent Application Publication
(10) Pub. No.: US 2024/0244685 A1
(43) Pub. Date: Jul. 18, 2024

(54) SENDING SYSTEM INFORMATION BLOCK INFORMATION BEFORE PC5-RADIO RESOURCE CONTROL SETUP

(71) Applicant: Telefonaktiebolaget LM Ericsson (PUBL), Stockholm (SE)

(72) Inventors: Antonino Orsino, KIRKKONUMMI (FI); Min Wang, LULEÅ (SE)

(21) Appl. No.: 18/559,868

(22) PCT Filed: May 10, 2022
(86) PCT No.: PCT/EP2022/062662

§ 371 Date: Nov. 9, 2023

Related U.S. Application Data
(60) Provisional application No. 63/186,323, filed on May 10, 2021.

(51) Int. Cl. H04W 76/14; H04W 48/14

(52) U.S. Cl. CPC H04W 76/14; H04W 48/14

(57) ABSTRACT

A method (1600) by a first wireless device (110) includes determining (1602) that at least one trigger condition has been fulfilled. In response to determining that at least one trigger condition has been fulfilled, the first wireless device transmits (1604) system information, SI, to a second wireless device. The SI is transmitted to the second wireless device before a sidelink, SL, connection is setup between the first wireless device and the second wireless device.

### TECHNICAL FIELD

The present disclosure relates, in general, to wireless communications and, more particularly, systems and methods for sending System Information Block (SIB) information before PC5-Radio Resource Control (PC5-RRC) setup.

### BACKGROUND

3GPP TS 38.300 discusses System Information (SI) handling in New Radio (NR) and Long Term Evolution (LTE).

FIG. 1 illustrates signalling between the wireless device such as, for example, a user equipment (UE) and a network node such as, for example, a gNodeB (gNB), for SI provisioning. As depicted, the gNB may transmit, to the wireless device (e.g., UE) minimum SI (MIB) broadcast on BCH; Minimum SI (SIB1) broadcast and/or unicast on the Downlink Shared Channel (DL-SCH); other SI (SIBn) broadcast or unicast on the DL-SCH; and/or other SI (SIBn) unicast on-demand on DL-SCH.

For a cell/frequency that the UE is considering for camping, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE shall consider that cell as barred.

The UE only acquires SI on the active Bandwidth Part (BWP).

The UE shall apply the SI acquisition procedure, as defined in clause 5.2.2.3 of 3GPP TS 38.331, upon cell selection (e.g. upon power on), upon cell-reselection, upon return from out of coverage, after reconfiguration with sync completion, after entering the network from another Radio Access Technology (RAT), upon receiving an indication that the system information has changed, upon receiving a Public Warning System (PWS) notification, upon receiving a positioning request from upper layers, and whenever the UE does not have a valid version of a stored SIB.

When the UE acquires a MIB or a SIB1 or an SI message in a serving cell, the UE stores the acquired SIB. If present in the SIB, the UE stores the associated areaScope, the first PLMN-Identity in the PLMN-IdentityInfoList for non-NPN-only cells, the first NPN-Identity (e.g., Standalone Non-Public Network (SNPN) identity, in case of SNPN, or Public Network Integrated-Non-Public Network (PNI-NPN) identity, in case of PNI-NPN, see 3GPP TS 23.501) in the NPN-IdentityInfoList for NPN-only cells, the cellIdentity, the systemInformationAreaID, and the valueTag, as indicated in the si-SchedulingInfo for the SIB. Thereafter, the UE may use a valid stored version of the SI (except MIB, SIB1, SIB6, SIB7 or SIB8) after cell re-selection, upon return from out of coverage, or after the reception of SI change indication. The value tag for Positioning System Information Block (posSIB) is optionally provided in LPP signalling.

### SI Change Indication and PWS Notification

A modification period is used. An updated SI message (other than SI message for Earthquake and Tsunami Warning System (ETWS), Commercial Mobile Alert System (CMAS) and positioning assistance data) is broadcasted in the modification period following the one where SI change indication is transmitted. The modification period boundaries are defined by System Frame Number (SFN) values for which SFN mod m=0, where m is the number of radio frames comprising the modification period. The modification period is configured by SI. The UE receives indications about SI modifications and/or PWS notifications using Short Message transmitted with Paging-Radio Network Temporary Identifier (P-RNTI) over Downlink Control Information (DCI). Repetitions of SI change indication may occur within preceding modification period. SI change indication is not applicable for SI messages containing posSIBs.

UEs in RRC_IDLE or in RRC_INACTIVE shall monitor for SI change indication in each UE's own paging occasion every Discontinuous Reception (DRX) cycle. UEs in RRC_CONNECTED shall monitor for SI change indication in any paging occasion at least once per modification period if the UE is provided with common search space on the active BWP to monitor paging. This is discussed in 3GPP TS 38.213, Clause 13.

ETWS or CMAS capable UEs in RRC_IDLE or in RRC_INACTIVE shall monitor for indications about PWS notification in each UE's own paging occasion every DRX cycle. ETWS or CMAS capable UEs in RRC_CONNECTED shall monitor for indication about PWS notification in any paging occasion at least once every defaultPagingCycle if the UE is provided with common search space on the active BWP to monitor paging.

For Short Message reception in a paging occasion, the UE monitors the PDCCH monitoring occasion(s) for paging as specified in 3GPP TS 38.304 and 3GPP TS 38.213.

### On Demand SI

An on demand SI request is a feature in NR that allows the network to broadcast some of the SI messages only when there is a UE that needs to acquire it. For example, the UE requests the SI messages using either msg1 or msg3 based procedures. The procedure allows a UE to request the needed content on demand, and it allows the network to minimize the overhead in constantly broadcasting information that no UE is currently acquiring.

Further, some of the SI messages can be provided to the UE also in dedicated state using the RRC Connection Reconfiguration message. For the RRC On demand SI framework, the parameter si-BroadcastStatus, is used to indicate if an SI message is currently being broadcasted or not:
si-BroadcastStatus ENUMERATED {broadcasting, notBroadcasting}

From UE perspective, the UE obtains the SI scheduling information for the SI message from SIB1 independent of whether an SI message is indicated as broadcasting or notBroadcasting. If the SI message is indicated as broadcasting, the UE can then directly acquire the SI message based on the SI scheduling information. However, if the SI message is indicated as notBroadcasting, the UE first needs to perform the on-demand SI request procedure to the base station in order to initiate the transmission of the SI message (according to the SI scheduling information).

Currently, the on-demand broadcast for UEs in RRC_IDLE/INACTIVE is based upon the following msg1 and msg3 solutions:
Broadcast (Msg1 option):
   Msg1 SI Request Random Access Channel (RACH) procedure (Physical Random Access Channel (PRACH), Random Access Response (RAR))
   Broadcast SI message (for some time)
Broadcast (Msg3 option):
   Msg3 SI Request RACH procedure (PRACH, RAR, RRCSystemInfoRequest, “Msg4”)
   Broadcast SI message (for some time)

Further in 3GPP, the following unicast (dedicated signaling) from idle/inactive is also currently being discussed:
Unicast (from IDLE/INACTIVE):
   Full RACH procedure (PRACH, RAR, RRC Setup/Resume Request, RRC Setup/Resume)
   On demand request message
   Dedicated SI message

For the case of UEs in RRC_CONNECTED, SIBs can be requested on-demand and the granularity is per SIB. In order to do so, the UE sends the DedicatedSIBRequest message with the requested SIBs, and the network may choose to broadcast them or to send them via dedicated signaling in the RRC reconfiguration message.

### NR Vehicle-to Anything (V2X)

Cellular Intelligent Transport Systems (C-ITS or ITS) aims at defining a new cellular eco-system for the delivery of vehicular services and their dissemination. FIG. 2 illustrates an C-ITS and includes both short range and long range V2X service transmissions. In particular, short range communication involves transmissions over the Device-to-Device (D2D) link, also defined as sidelink (SL) or PC5 interface in 3GPP, towards other vehicular UEs or road side units (RSU). On the other hand, for long range transmission, transmission between a UE and a base station is over the Uu interface. In this manner, packets may be disseminated to different ITS service providers, which could be road traffic authorities, road operators, automotive OEMs, cellular operators, etc.

When it comes to the SL interface, the first standardization effort in 3GPP dates back to Release 12, targeting public safety use cases. Since then, a number of enhancements have been introduced with the objective of enlarging the use cases that could benefit from the D2D technology. Particularly, in LTE Release 14 and Release 15, the extensions for the D2D work consists of supporting V2X communication, including any combination of direct communication between vehicles (V2V), pedestrians (V2P), and infrastructure (V2I).

In RAN #80, a Study Item named “Study on NR V2X” was approved to study an enhancement to support advanced V2X services beyond services supported in LTE Rel-15 V2X. One of the objectives for NR V2X design is to study technical solutions for Quality of Service (QOS) management of the radio interface including both Uu (i.e. network-to-vehicle UE communication) and SL (i.e. vehicle UE-to-vehicle UE communication) used for V2X operations.

While LTE V2X mainly aims at traffic safety services, NR V2X has a much broader scope, including not only basic safety services, but also targeting non-safety applications such as extended sensor/data sharing between vehicles, with the objective to strengthen the perception of the surrounding environment of vehicles. Thus, a new set of applications have been captured in 3GPP TR 22.886 v16.2.0, such as advanced driving, vehicles platooning, cooperative maneuver between vehicles and remote driving that would require enhanced NR system and new NR SL framework.

In this context, the expected requirements to meet the needed data rate, capacity, reliability, latency, communication range, and speed are made more stringent. What is more, both communication interfaces, PC5 and Uu, could be used to support the advanced V2X use cases, taking into account radio conditions and the environment where the enhanced V2X (eV2X) scenario takes place. For example, given the variety of services that can be transmitted over the SL, a robust QoS framework which takes into account the different performance requirements of the different V2X services seems to be needed.

### NR SL Flow and Radio Bearer Configuration Provision

In NR, a SL QoS flow model is adopted. At the Non-access Stratum (NAS) layer, UE maps one V2X packet into the corresponding SL QoS flow and then maps to a SL radio bearer at Service Data Adaptation Protocol (SDAP) layer.

In NR, a SL radio bearer (SLRB) configuration, including the QoS flow to SLRB mapping, is either preconfigured or configured by the network (NW) when the UE is in coverage. FIG. 3 illustrates a NR SL Radio Bearer Configuration being provided by the NW.

For instance, as shown in FIG. 3, when the UE wants to establish a new SL QOS flow/SLRB for a new service, the UE sends a request to the associated gNB. The request can include the QoS information of the service. The gNB then determines an appropriate SLRB configuration to support such SL QoS flow and sends the SRLB configuration to the UE. After receiving the SLRB configuration from gNB, the UE establishes the local SLRB according to the SRLB configuration and prepares for data transmission over the SL. Note that to enable successful reception at the reception/receiver (RX) UE side, transmission/transmitter (TX) UE might have to inform RX UE regarding necessary parameters such as, for example, sequence number space for Packet Data Convergence Protocol (PDCP)/Radio Link Control (RLC) before the data transmission starts.

### NR Frame Structure

Similar to LTE, NR uses Orthogonal Frequency Division Multiplexing (OFDM) in the DL (i.e. from a network node (e.g. gNB, eNodeB (eNB), or base station) to a UE). The basic NR physical resource over an antenna port can thus be seen as a time-frequency grid. FIG. 4 illustrates such an NR Physical Resource Grid, where a resource block (RB) in a 14-symbol slot is shown. A RB corresponds to 12 contiguous subcarriers in the frequency domain. RBs are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈(0, 1, 2, 3, 4). Δf=15 kHz is the basic (or reference) subcarrier spacing that is also used in LTE.

In the time domain, downlink (DL) and uplink (UL) transmissions in NR will be organized into equally-sized subframes of 1 ms each similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols.

DL transmissions are dynamically scheduled. For example, in each slot, the gNB transmits DCI about which UE data is to be transmitted to and which RBs in the current DL slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the DL assignment provided by decoded control information in the PDCCH.

In addition to PDCCH and PDSCH, there are also other channels and reference signals transmitted in the downlink, including Synchronization Signal Block (SSB), Channel State Information-Reference Signal (CSI-RS), etc.

UL data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

### SL Transmissions in NR

SL transmissions over NR are specified for Release 16. These are enhancements of the PROximity-based Services (ProSe) specified for LTE. Four new enhancements are particularly introduced to NR SL transmissions as follows:
Support for unicast and groupcast transmissions are added in NR SL. For unicast and groupcast, the physical SL feedback channel (PSFCH) is introduced for a receiver UE to reply the decoding status to a transmitter UE.
Grant-free transmissions, which are adopted in NR UL transmissions, are also provided in NR SL transmissions, to improve the latency performance.
To alleviate resource collisions among different SL transmissions launched by different UEs, it enhances channel sensing and resource selection procedures, which also lead to a new design of Physical Sidelink Control Channel (PSCCH).
To achieve a high connection density, congestion control and thus the QoS management is supported in NR SL transmissions.

To enable the above enhancements, new physical channels and reference signals are introduced in NR (available in LTE before):
PSSCH: The PSSCH is the SL version of PDSCH and is transmitted by a SL transmitter UE, which conveys SL transmission data, SIBs for RRC configuration, and a part of the SL control information (SCI).
Physical Sidelink feedback channel (PSFCH): The PSFCH is transmitted by a SL receiver UE for unicast and groupcast, which conveys 1 bit information over 1 RB for the Hybrid Automatic Repeat Request (HARQ) acknowledgement (ACK) and the negative ACK (NACK). In addition, channel state information (CSI) is carried in the medium access control (MAC) control element (CE) over the PSSCH instead of the PSFCH.
Physical Sidelink Common Control Channel (PSCCH) (SL version of PDCCH): When the traffic to be sent to a receiver UE arrives at a transmitter UE, a transmitter UE should first send the PSCCH, which conveys a part of SCI (SL version of DCI) to be decoded by any UE for the channel sensing purpose, including the reserved time-frequency resources for transmissions, demodulation reference signal (DMRS) pattern, antenna port, etc.
Sidelink Primary Synchronization Signal (S-PSS)/Secondary Synchronization Signal (S-SSS): Similar to DL transmissions in NR, in SL transmissions, S-PSS and S-SSS are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter. The process(es) for acquiring timing and frequency synchronization, together with SSIDs of UEs, is called initial cell search. Note that the UE sending the S-PSS/S-SSS may not be necessarily involved in SL transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot, and symbol level time resources for SL transmissions, in-coverage indicator, etc. The SSB is transmitted periodically every 160 ms.
DMRS, phase tracking reference signal (PT-RS), CSI-RS: These physical reference signals supported by NR downlink/UL transmissions are also adopted by SL transmissions. Similar to NR, the PT-RS is only applicable for FR2 transmission.

Another new feature is the two-stage SCI. This a version of DCI for SL. Unlike DCI, only part (first stage) of the SCI is sent on the Physical Sidelink Control Channel (PSCCH). This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, New Data Indicator (NDI), Redundancy Value (RV), and HARQ process ID is sent on the PSSCH to be decoded by the receiver UE.

Similar as for Proximity Services (PROSE) in LTE, NR SL transmissions have the following two modes of resource allocations:
Mode 1: SL resources are scheduled by a gNB.
Mode 2: The UE autonomously selects SL resources from preconfigured SL resource pool(s) based on a channel sensing mechanism.

For the in-coverage UE, a gNB can be configured to adopt Mode 1 or Mode 2. For the out-of-coverage UE, only Mode 2 can be adopted.

As in LTE, scheduling over the SL in NR is done in different ways for Mode 1 and Mode 2.

Mode 1 supports the following two kinds of grants:
Dynamic grant: When the traffic to be sent over SL arrives at a transmitter UE, this UE should launch the four-message exchange procedure to request SL resources from a gNB (SR on UL, grant, Buffer Status Report (BSR) on UL, grant for data on SL sent to UE). During the resource request procedure, a gNB may allocate a SL radio network temporary identifier (SL-RNTI) to the transmitter UE. If this SL resource request is granted by a gNB, then a gNB indicates the resource allocation for the PSCCH and the PSSCH in the DCI conveyed by PDCCH with Cyclic Redundancy Check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for SL transmissions. When a grant is obtained from a gNB, a transmitter UE can only transmit a single Transport Block (TB). As a result, this kind of grant is suitable for traffic with a loose latency requirement.
Configured grant: For the traffic with a strict latency requirement, performing the four-message exchange procedure to request SL resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a SL receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, the transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and, thus, suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in SL transmissions should autonomously select resources for above transmissions, how to prevent different transmitter UEs from selecting the same resources turns out to be a critical issue in Mode 2. A particular resource selection procedure is, therefore, imposed to Mode 2 based on channel sensing. The channel sensing algorithm involves measuring Reference Signal Received Power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

### NR SL Relay

### Layer 2 (L2) UE-to-Network Relay

3GPP TR 23.752, Clause 6.7 describes the layer-2 (L2) based UE-to-Network relay.

FIG. 5 illustrates User Plane Stack for L2 UE-to-Network Relay UE, as discussed in 3GPP TR 23.752.

The adaptation relay layer within the UE-to-Network Relay UE can differentiate between signalling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

FIG. 6 illustrates the protocol stack of the NAS connection for the Remote UE to the NAS-MM and NAS-SM components, as discussed in 3GPP TR 23.752. Specifically, FIG. 6 illustrates the control plane for L2 UE-to-Network Relay UE. The NAS messages are transparently transferred between the Remote UE and 5G-AN over the L2 UE-to-Network Relay UE using:
PDCP end-to-end connection where the role of the UE-to-Network Relay UE is to relay the PDUs over the signalling radio bear without any modifications.
N2 connection between the 5G-AN and AMF over N2.
N11 connection AMF and SMF over N11.

The role of the UE-to-Network Relay UE is to relay the PDUs from the signaling radio bearer without any modifications.

### Layer 3 (L3) UE-to-Network Relay

3GPP TR 23.752, Clause 6.6 discloses the layer-3 (L3) based UE-to-Network relay.

FIG. 7 illustrates an Architecture model using ProSe 5G UE-to-Network Relay, as discussed in 3GPP TR 23.752.

The protocol stack for L3 UE-to-Network Relays as described in 3GPP TR 23.752 is shown in FIG. 8.

Hop-by-hop security is supported in the PC5 link and Uu link. If there are requirements beyond hop-by-hop security for protection of Remote UE's traffic, security over IP layer needs to be applied.

Certain problems exist, however. For example, before connecting to a relay UE via unicast PC5 link, the remote UE in L2 relay system needs to obtain at least the following information from the gNB when intended to establish RRC connection:
Cell access parameters (e.g. PLMN identity, cell identity, and cell barring info)
Configuration to initialize RRC connection establishment (e.g. values of timer T300/T319)
UAC configuration

These parameters are generally included in Uu MIB/SIB1. However, in case the remote UE is out-of-coverage (OOC), there is no means at the moment for the remote UE to acquire such information. Without this information, the remote UE may select a relay UE connecting to a unsuitable cell, so that the remote UE would need to re-select another relay UE causing longer access latency, which is not accepted for delay sensitive services.

### SUMMARY

Certain aspects of the present disclosure and their embodiments may provide solutions to these or other challenges. For example, according to certain embodiments, methods and systems are provided that allow the remote UE, that is OOC, to receive necessary information generally present in SIB/MIB from the relay UE.

According to certain embodiments, a method by a first wireless device includes determining that at least one trigger condition has been fulfilled. In response to determining that at least one trigger condition has been fulfilled, the first wireless device transmits SI to a second wireless device. The SI is transmitted to the second wireless device before a SL connection is setup between the first wireless device and the second wireless device.

According to certain embodiments, a first wireless device is adapted to determine that at least one trigger condition has been fulfilled. In response to determining that at least one trigger condition has been fulfilled, the first wireless device is adapted to transmit SI to a second wireless device. The SI is transmitted to the second wireless device before a SL connection is setup between the first wireless device and the second wireless device.

According to certain embodiments, a method by a second wireless device includes receiving SI from a first wireless device. The SI is received from the first wireless device before a SL connection is setup between the first wireless device and the second wireless device.

According to certain embodiments, a second wireless device is adapted to receive SI from a first wireless device. The SI is received from the first wireless device before a SL connection is setup between the first wireless device and the second wireless device.

According to certain embodiments, a method by a network node includes transmitting, to a first wireless device, an indication that SI may be sent from the first wireless device to a second wireless device before a SL connection is setup between the first wireless device and the second wireless device.

According to certain embodiments, a network node is adapted to transmit, to a first wireless device, an indication that SI may be sent from the first wireless device to a second wireless device before a SL connection is setup between the first wireless device and the second wireless device.

Certain embodiments may provide one or more of the following technical advantages. For example, a technical advantage may be that certain embodiments allow the remote UE, that is in OOC, to receive necessary information generally present in SIB/MIB from the relay UE. As such, a further technical advantage may be that the remote UE is able to perform RRC connection management procedure towards the gNB without the risk of being rejected since, for example, the UAC parameters will be known. Additionally or alternatively, another technical advantage may be that the SL relay connection setup may be much faster because the remote UE can access the network right away when the PC5-RRC signalling is established. The relay UE forwards the SIB without waiting after that.

As another example, a technical advantage may be that certain embodiments result in less signaling overhead as the PC5-RRC connection is established only if the remote UE is able to access the serving cell of the relay UE (e.g., meaning the serving cell of the relay UE is not barred).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates signalling between a wireless device and a network node for SI provisioning;

FIG. 2 illustrates an C-ITS;

FIG. 3 illustrates an NR SL Radio Bearer Configuration being provided by the NW;

FIG. 4 illustrates such an NR Physical Resource Grid;

FIG. 5 illustrates User Plane Stack for L2 UE-to-Network Relay UE;

FIG. 6 illustrates the protocol stack of the NAS connection for the Remote UE to the NAS-MM and NAS-SM components;

FIG. 7 illustrates an Architecture model using ProSe 5G UE-to-Network Relay;

FIG. 8 illustrates the protocol stack for L3 UE-to-Network Relays;

FIG. 9 illustrates an example wireless network, according to certain embodiments;

FIG. 10 illustrates an example network node, according to certain embodiments;

FIG. 11 illustrates an example wireless device, according to certain embodiments;

FIG. 12 illustrate an example user equipment, according to certain embodiments;

FIG. 13 illustrates a virtualization environment in which functions implemented by some embodiments may be virtualized, according to certain embodiments;

FIG. 14 illustrates a telecommunication network connected via an intermediate network to a host computer, according to certain embodiments;

FIG. 15 illustrates a generalized block diagram of a host computer communicating via a base station with a user equipment over a partially wireless connection, according to certain embodiments;

FIG. 16 illustrates a method implemented in a communication system, according to one embodiment;

FIG. 17 illustrates another method implemented in a communication system, according to one embodiment;

FIG. 18 illustrates another method implemented in a communication system, according to one embodiment;

FIG. 19 illustrates another method implemented in a communication system, according to one embodiment;

FIG. 20 illustrates an example method by a wireless device, according to certain embodiments;

FIG. 21 illustrates an example virtual apparatus, according to certain embodiments;

FIG. 22 illustrates an example method by a network node in communication with a wireless device that operates as a relay for at least one additional wireless device, according to certain embodiments;

FIG. 23 illustrates another example virtual apparatus, according to certain embodiments;

FIG. 24 illustrates an example method by a wireless device that operates as a remote wireless device with respect to at least one of a relay wireless device and/or a network node, according to certain embodiments;

FIG. 25 illustrates another example virtual apparatus, according to certain embodiments;

FIG. 26 illustrates another example method by a wireless device, according to certain embodiments;

FIG. 27 illustrates another example method by a wireless device, according to certain embodiments; and

FIG. 28 illustrates another example method by a network node, according to certain embodiments.

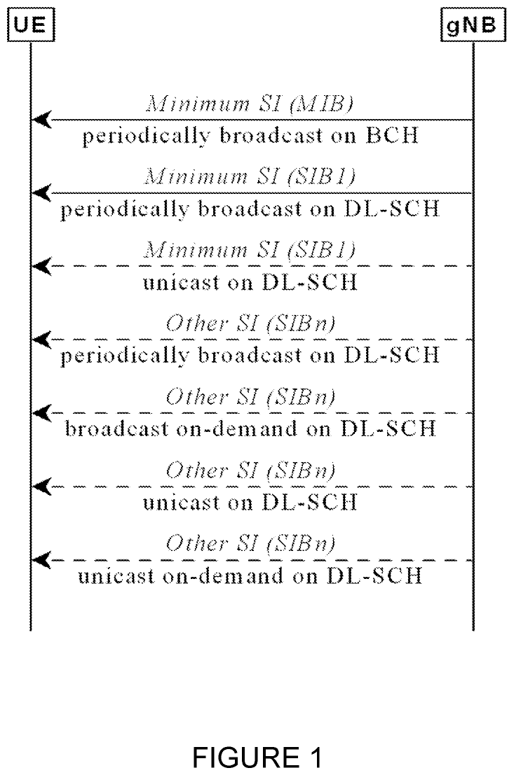

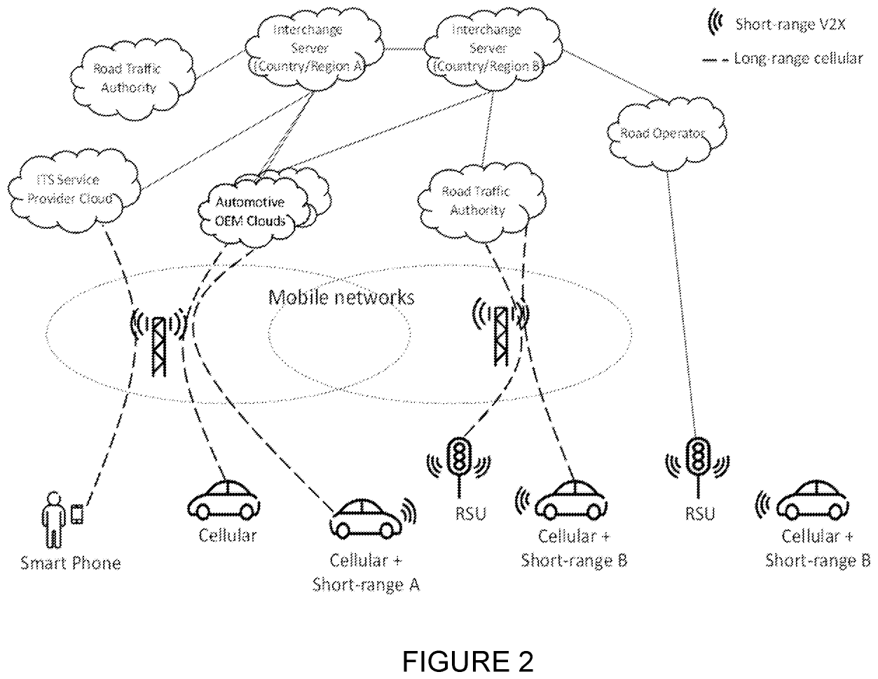

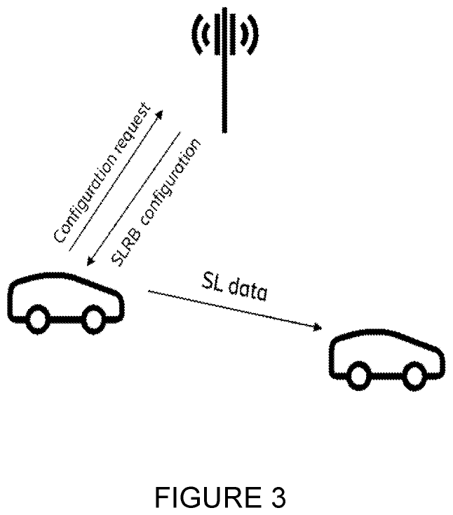

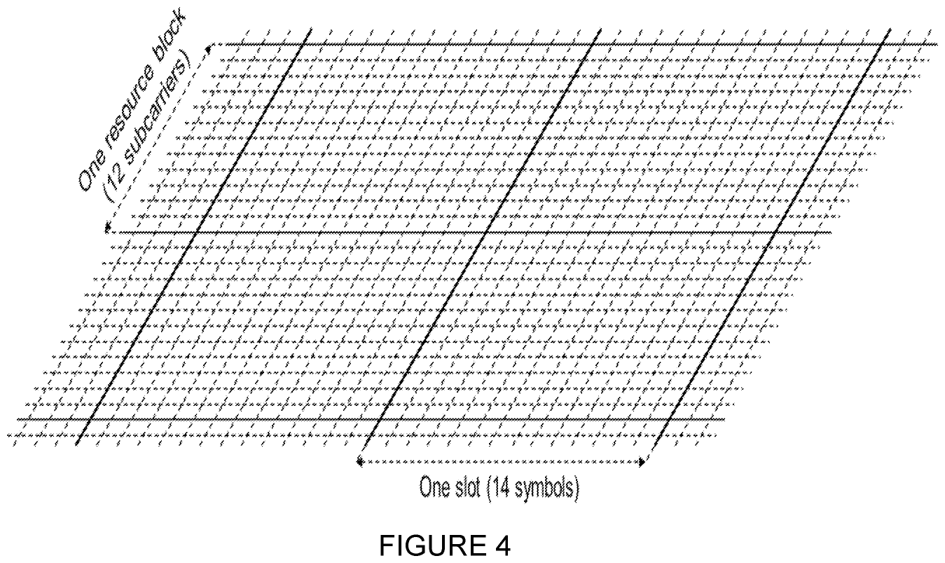

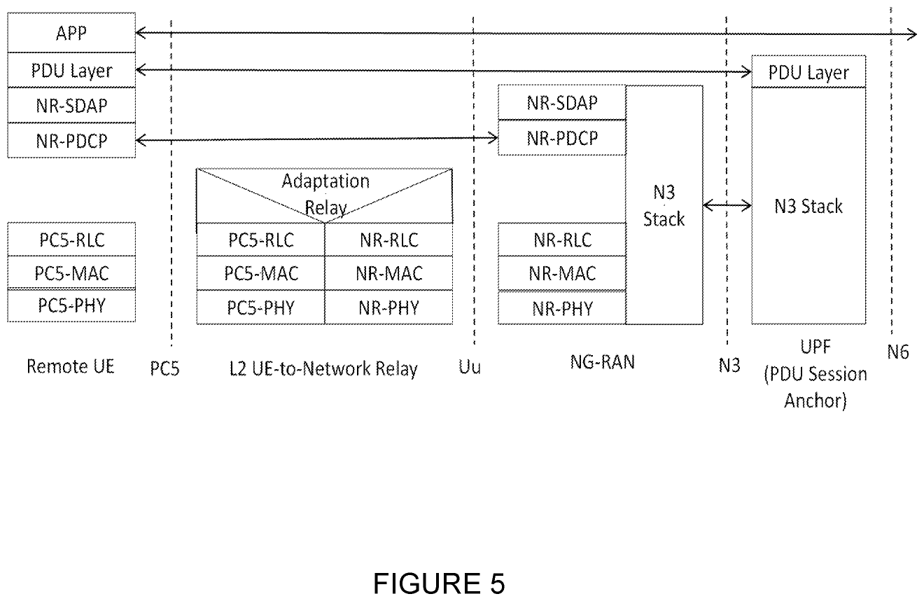

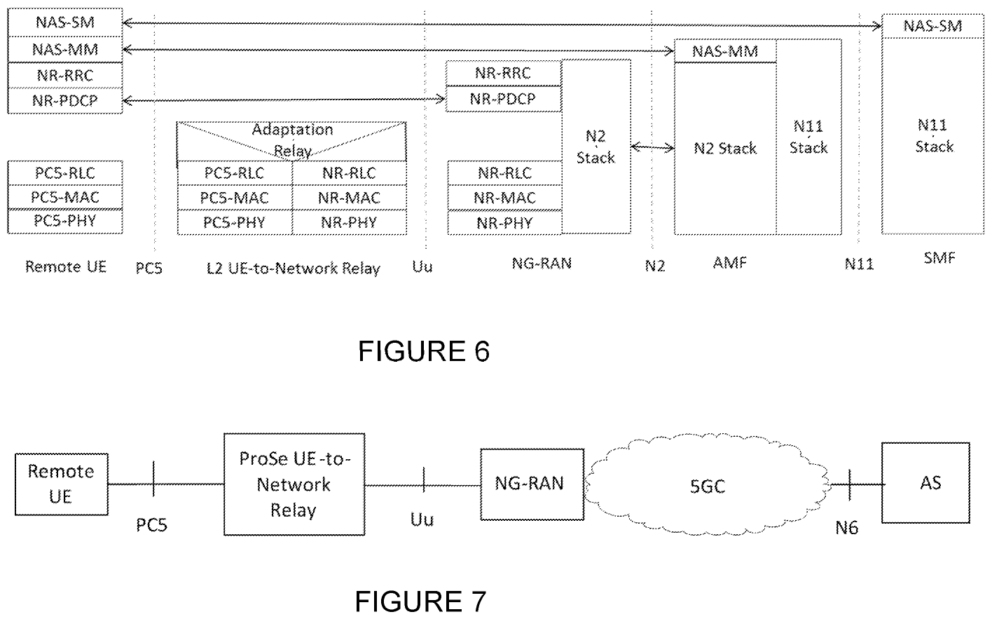

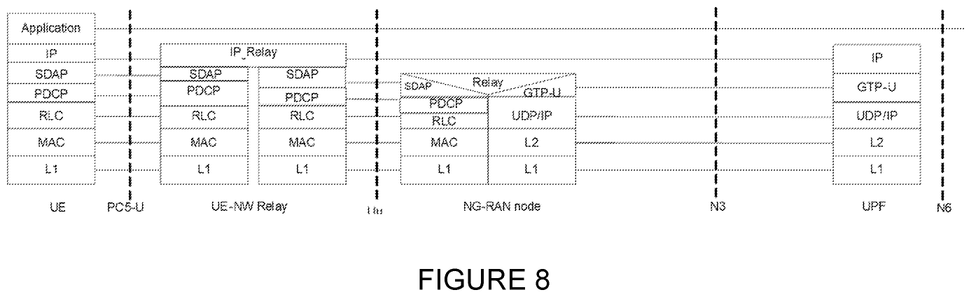

### DETAILED DESCRIPTION

Some of the embodiments contemplated herein will now be described more fully with reference to the accompanying drawings. Other embodiments, however, are contained within the scope of the subject matter disclosed herein; the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, eNodeB (eNB), gNodeB (gNB), Master eNB (MeNB), a network node belonging to Master Cell Group (MCG) or Secondary Cell Group (SCG), base station (BS), multi-standard radio (MSR) radio node such as MSR BS, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. Evolved-Serving Mobile Location Center (E-SMLC)), Minimization of Drive Tests (MDT), test equipment (physical node or software), etc.

In some embodiments, the non-limiting term UE or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UE (ProSe UE), Vehicle-to-Vehicle UE (V2V UE), Vehicle-to-Anything UE (V2X UE), etc.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB or UE.

The methods and solutions disclosed in the following, are referring to the NR Radio Access Technology (RAT) but can be applied also to LTE RAT and any other RAT enabling the direct transmission between two (or more) nearby devices without any loss of meaning.

In the following SL relay includes a communication that is generated by a remote UE and is terminated at a gNB (or another destination remote UE) via the use of an intermediate node. The intermediate node is referred to as a relay UE or RL UE.

In the following, the remote UE that needs to transmit packets to and/or receive packet from the gNB or another UE via the intermediate node (relay UE) is referred to as a remote UE or RM UE.

In the following, the other UE that receives packets from a remote UE via a relay UE is called a target remote UE.

In the following, the terms “SI” and “SIB” are used, and these terms can be used interchangeably without any loss of meaning. Also, the assumption in the following is that the SL SIB is segmented by the network where its size exceeds the maximum size to be sent over the broadcast channel.

According to certain embodiments, a UE that is SL relay capable (thus able to be at least a relay UE) may be configured by a configuration to provide the full (or a part) of the system information (SIB or SI) before setting up PC5-RRC connection with one or multiple remote UEs.

According to certain embodiments, methods and systems are provided that allow the remote UE, that is OOC, to receive necessary information generally present in SIB/MIB from the relay UE. According to certain embodiments, in order to do so, at least one of the following solutions may be applied:
The gNB configures the relay UE to send necessary system information to one or more remote UE(s) before or after setting up a PC5-RRC connection.
   The relay UE may send this essential information when replying to a received discovery message.
   The relay UE may simply broadcast/groupcast this necessary information (meaning that all the possible remote UEs in proximity are reached).
   For relay service or relay traffic type with critical Qos requirements (e.g., with critical latency requirement), the system information is sent to remote UE before setting up PC5-RRC connection.
   For relay service or relay traffic type with non-critical QoS requirements (e.g., with non-critical latency requirement), the system information is sent to remote UE after setting up PC5-RRC connection.
The configuration on what necessary system information should be shared can be linked to e.g., a specific access category, QoS traffic, UE location or Radio Access Network (RAN) area.
Once the relay UE is configured to send necessary system information to one or more remote UE(s) before setting up a PC5-RRC connection, the relay UE sends such necessary system information when at least one of the following triggering conditions are fulfilled:
   Upon receiving at least one discovery message from a neighbor UE
   When the relay UE battery percentage is above a predefined threshold
   Only if certain services or traffic types are supported by the relay UE
   Upon indication from the serving gNB of the relay UE
   If a certain QoS requirement needs to be handled
   Upon the reception of a SIB/MIB over Uu.

According to a particular embodiment, the configuration that the relay UE received may comprise at least one of the following information:
Indication/indicators that indicate how the system information shall be forwarded to the remote UE (according to at least one of the following)
   Indicators indicating whether the system information is allowed to be forwarded to the remote UE
   Indicators indicating whether the system information is allowed to be forwarded to remote UE before setting up the PC5-RRC connection with the remote UE
      An indication that may be in the form of a Boolean field (i.e., true or false), a one-bit indicator (1 the relay provides system information before establishing a PC5-RRC connection and 0 if should not—or vice versa), or just a text string that it indicates to the relay UE that is allowed to provide the full (or a part) of the system information (SIB or SI) before setting up a PC5-RRC connection with one or multiple remote UEs. There may be multiple bits/indicators, wherein each of them indicates whether a certain type of SIB or group of SIBs are allowed to be forwarded to a remote UE before setting up the PC5-RRC connection with the remote UE.
   Indicators indicating whether the system information is allowed to be forwarded to remote UE after setting up the PC5-RRC connection with the remote UE. There may be multiple bits/indicators, wherein each of them indicates whether a certain type of SIB or group of SIBs are allowed to be forwarded to a remote UE after setting up the PC5-RRC connection with the remote UE.
Whether full SIB(s) or only part of SIB(s) (e.g., only certain fields/configurations contained in a SIB) should be delivered to the remote UE.
Whether unicast, broadcast, or groupcast should be used for the delivery of the necessary system information. If the configuration indicates “unicast” this basically mean that the relay UE sends this system information only in reply to a message receive from a possible remote UE. Whereas if the configuration it indicates broadcast of groupcast, the relay UE is start to broadcast/groupcast the necessary system information to all the possible remote UEs in proximity.
When this configuration should be used. This basically mean that the configuration is linked to more or more conditions and the relay UE can use this configuration only is at least one of these conditions are fulfilled. These conditions can be:
   A specific access category
   A certain QoS traffic or requirement
   A specific service that is supported by the relay UE
   Geographical location
   RAN area
   Tracking area
   Certain RSRP, Reference Signal Received Quality (RSRQ), or Signal Interference to Noise Ratio (SINR) levels
A configuration ID

According to certain other embodiments, a UE that is SL relay capable (thus able to be at least a relay UE) is configured with multiple configurations that allows/not allow relay UE to provide the full (or a part or specific SIB types) of the system information (SIB or SI) before setting up a PC5-RRC connection with one or multiple remote UEs. When multiple configurations are provided to the relay UE, the relay UE may be indicated (e.g., via the configuration ID) to use a certain configuration (or to switch among them) via direct RRC signalling or via broadcast or groupcast.

According to certain other embodiments, if a UE that is SL capable (thus able to be at least a relay UE) is configured to provide the full (or a part or specific SIB types) of the system information (SIB or SI) before setting up a PC5-RRC connection with one or multiple remote UEs, the necessary system information are sent before to establish a PC5-RRC connection when at least one of the following triggers are fulfilled:
When a discovery message is received by the UE in proximity. In this case, the UE may decide to send the necessary system information right before to reply to the received discovery message or within the message that is used as a reply to the received discovery message.
When the UE battery percentage is above a threshold. This is basically to guarantee that the UE does not drain its battery if the reaming charge is low.
Only if a certain service or traffic is supported by the UE or if these services or traffics are advertised in the received discovery message. For delay sensitive services or traffic types, forwarding SIB to the remote UE before PC5-RRC connection is setup, would be beneficial so that the remote UE can select a suitable relay UE.
Upon an explicit indication from the gNB
When a certain QoS requirements should be fulfilled.
Every time that the UE receive a new SIB or MIB from the network.

According to certain other embodiments, a remote UE monitors possible system information forwarding according to the service or traffic type which is going to be employed on the relay link. For a service or traffic type with critical QoS requirements (e.g., with critical latency requirement), the remote UE is allowed to monitor system information for potential system information reception from a relay UE candidate before setting up PC5-RRC connection with the relay UE candidate. For a service or traffic type with non-critical QoS requirements (e.g., with non-critical latency requirement), the remote UE is allowed to monitor system information for potential system information reception from a relay UE candidate after setting up PC5-RRC connection with the relay UE candidate.

According to certain embodiments, a remote UE monitors possible system information forwarding according to a configuration, which is configured by a gNB or a relay UE, or another controlling UE. The configuration may be also possible to be preconfigured to the remote UE. In a particular embodiment, the configuration indicates to the remote UE when the remote UE shall monitor system information for potential system information reception from a relay UE candidate, i.e., before or after setting up PC5-RRC connection with the relay UE candidate.

According to a particular embodiment, for any of the above embodiments, the option or method used by the UE is decided by the gNB and communicated to the UE via dedicated RRC signaling of via system information. As an alternative, which option the UE should use is decided by a peer UE (e.g., remote UE) or is preconfigured (hard-coded in the spec).

According to a particular embodiment, for any of the above embodiments, the signaling alternatives between the UE and the gNB may include any one or more of: RRC signaling; MAC CE; and L1 signaling on channels such as PRACH, PUCCH, PDCCH, CCCH. The signaling alternatives between UEs may include any one or more of: RRC signaling (e.g., PC5-RRC); PC5-S signaling; Discovery signaling; MAC CE; and L1 signaling on channels such as PSSCH, PSCCH, or PSFCH.

### Additional Triggers for Initiating Transmission of SI Before SL Setup

As noted above, a first wireless device (e.g., relay UE) may receive a first discovery message from a peer, second wireless device (e.g., remote UE) that is looking to establish a sidelink relay connection or a normal connection. In a particular embodiment, the first discovery message may include an explicit indication from the second wireless device to send the SI before a relay connection or normal connection is established with the second wireless device. The first wireless device may send the SI before the relay connection or normal connection is established based on the explicit indication from the second wireless device.

Additionally or alternatively, according to certain embodiments, the first discovery message may be for a particular service, traffic, and/or application requested by the second wireless device (e.g., remote UE). Thus, in a particular embodiment, the first discovery message may include information identifying the service, traffic, and/or application for which the second wireless device is looking to establish the sidelink relay or normal connection. In this case, the first wireless device (e.g., relay UE) may reply first to the first discovery message with a second discovery message, which informs the second wireless device that the first wireless device is able to fulfil what the second wireless device is asking for. Thus, the second discovery message may indicate that the first wireless device is able to support the service traffic, and/or application for which the second wireless device is seeking service.

In a particular embodiment, the first wireless device may send the full or partial SI before the second discovery message is transmitted to the second wireless device. In another embodiment, the first wireless device may send the full or partial SI after the second discovery message is transmitted to the second wireless device. In still another embodiment, the first wireless device may send the full or partial SI in the second discovery message. In any case, the full or partial SI is sent to the second wireless device before the sidelink relay or normal relay connection is established with the second wireless device.

As discussed above, a first wireless device may transmit SI before a relay connection is established when a UE battery percentage or level is above a threshold. In a particular embodiment, the UE battery percentage or level that is considered may be that of the first wireless device (e.g., relay UE). Additionally or alternatively, the UE battery percentage or level that is considered by the first wireless device may be that of the second wireless device (e.g., remote UE). Thus, the battery percentage or level of either or both UEs may be considered when determining whether SI is to be sent before a relay or normal connection is established between the two devices, according to various embodiments.

Likewise, it may be recognized that the UE battery level or percentage that is considered may be that of the UE receiving the first discovery message or the UE sending the first discovery message.

In a particular embodiment, the first discovery message may include a battery percentage or level that is currently associated with the second wireless device (e.g., remote UE) and the first wireless device (e.g., relay UE) may determine to send SI to the second wireless device before the relay or normal connection is established between the two devices if the UE battery percentage or level of the second wireless device is greater than a threshold. This may ensure that sending the SI does not drain the battery life of the second wireless device.

Additionally or alternatively, according to certain embodiments, the first wireless device may send the SI before the relay or normal connection is established based on a QoS profile associated with a requested or advertised service. For example, the second wireless device may send a discover message that requests (or advertises) a service, application, or traffic. In a particular embodiment, the discovery message may include a QoS profile for the requested service, application or traffic. The first wireless device may then determine whether to send the SI before the relay connection or normal connection is established with the second wireless device based on the QoS profile for the requested service, application, or traffic.

In a particular embodiment, the QoS profile in the first discovery message can be explicit, meaning that an explicit field with QoS information is included in the first discovery message.

In another embodiment, the QoS profile may be implicitly indicated. For example, the QoS profile may implicitly derived by the first wireless device based on information provided in the first discovery message. For example, the first discovery message may indicate a Relay Service Code (RSC) or other identifier that represents an associated service, application, and/or traffic. The first wireless device may determine the QoS profile (and whether to send the SI before the relay connection is established) based on the RSC and/or the associated service, application, and/or traffic.

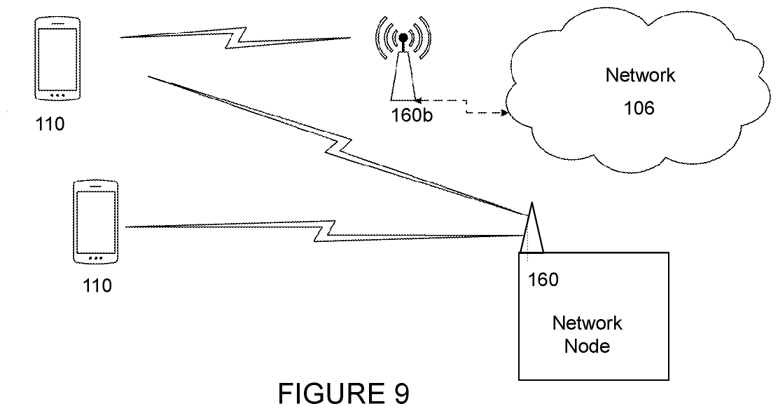

FIG. 9 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), LTE, and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

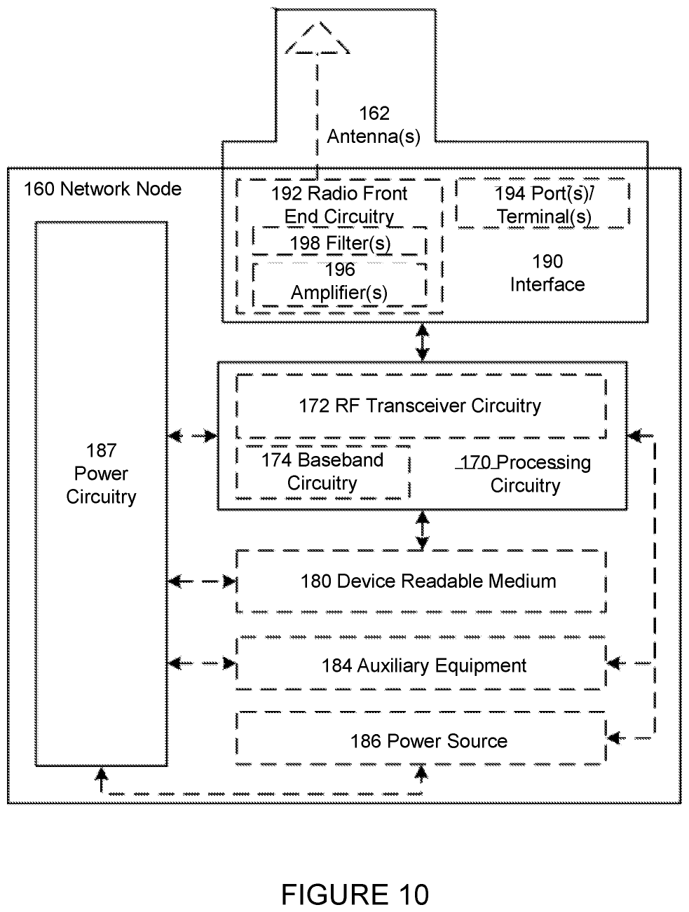

FIG. 10 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, APs (e.g., radio access points), BSs (e.g., radio base stations, Node Bs, eNBs and gNBs). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or RRUs, sometimes referred to as RRHs. Such remote radio units may or may not be integrated with an antenna as an antenna integrated radio. Parts of a distributed radio base station may also be referred to as nodes in a DAS. Yet further examples of network nodes include MSR equipment such as MSR BSs, network controllers such as RNCs or BSCs, BTSs, transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 160 includes processing circuitry 170, device readable medium 180, interface 190, auxiliary equipment 184, power source 186, power circuitry 187, and antenna 162. Although network node 160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple RATs. In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, RF transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHZ and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 10 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

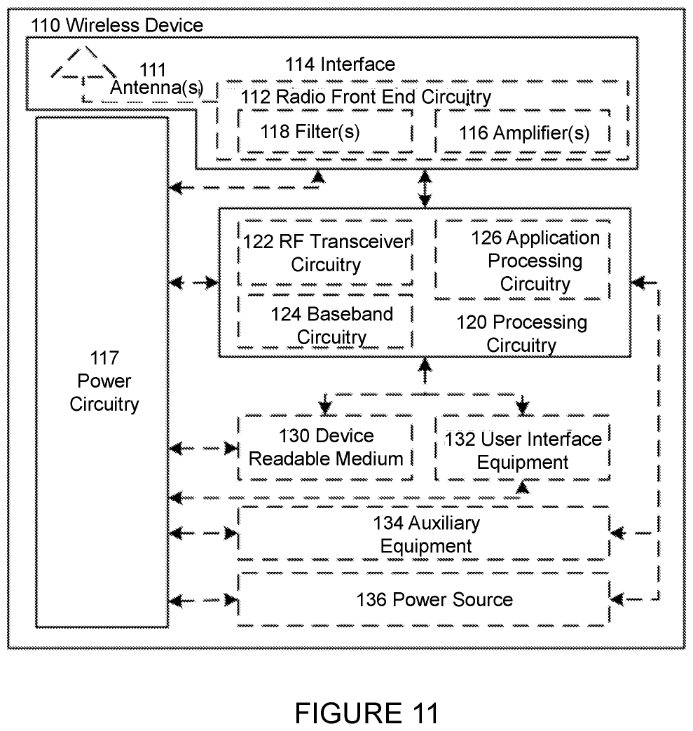

FIG. 11 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with UE. Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a PDA, a wireless cameras, a gaming console or device, a music storage device, a playback appliance, a wearable terminal device, a wireless endpoint, a mobile station, a tablet, a laptop, a LEE, a LME, a smart device, a wireless customer-premise equipment (CPE), a vehicle-mounted wireless terminal device, etc. A wireless device may support D2D communication, for example by implementing a 3GPP standard for SL communication, V2V. V2I, V2X and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a M2M device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

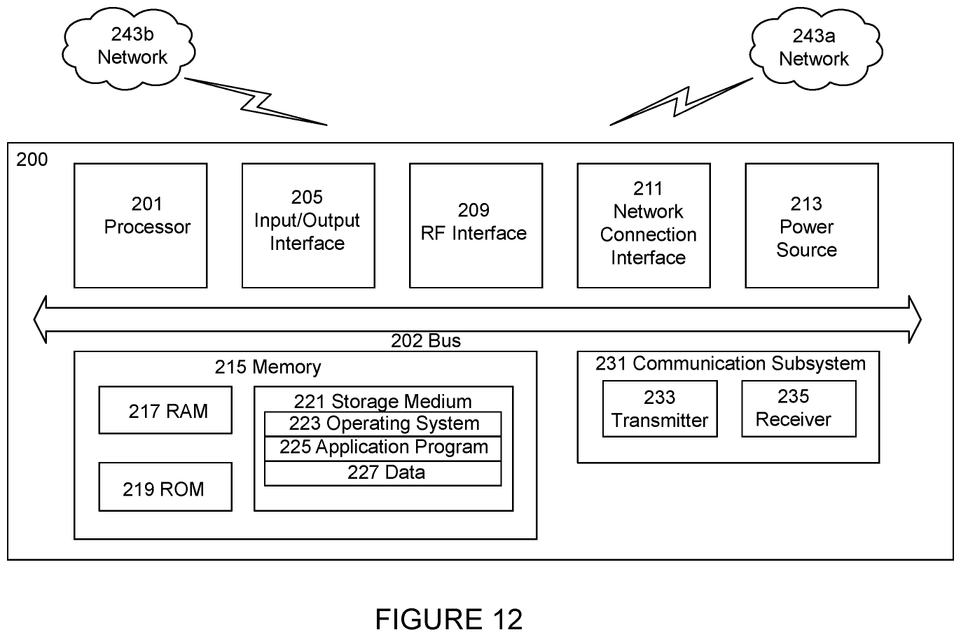

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3GPP, including a NB-IoT UE, a machine type communication (MTC) UE, and/or an enhanced MTC (eMTC) UE. UE 200, as illustrated in FIG. 10, is one example of a wireless device configured for communication in accordance with one or more communication standards promulgated by the 3GPP, such as 3GPP's GSM, UMTS, LTE, and/or 5G standards. As mentioned previously, the term wireless device and UE may be used interchangeable. Accordingly, although FIG. 12 is a UE, the components discussed herein are equally applicable to a wireless device, and vice-versa.

In FIG. 12, UE 200 includes processing circuitry 201 that is operatively coupled to input/output interface 205, RF interface 209, network connection interface 211, memory 215 including RAM 217, ROM 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a WAN, a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 12, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a LAN, a WAN, a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

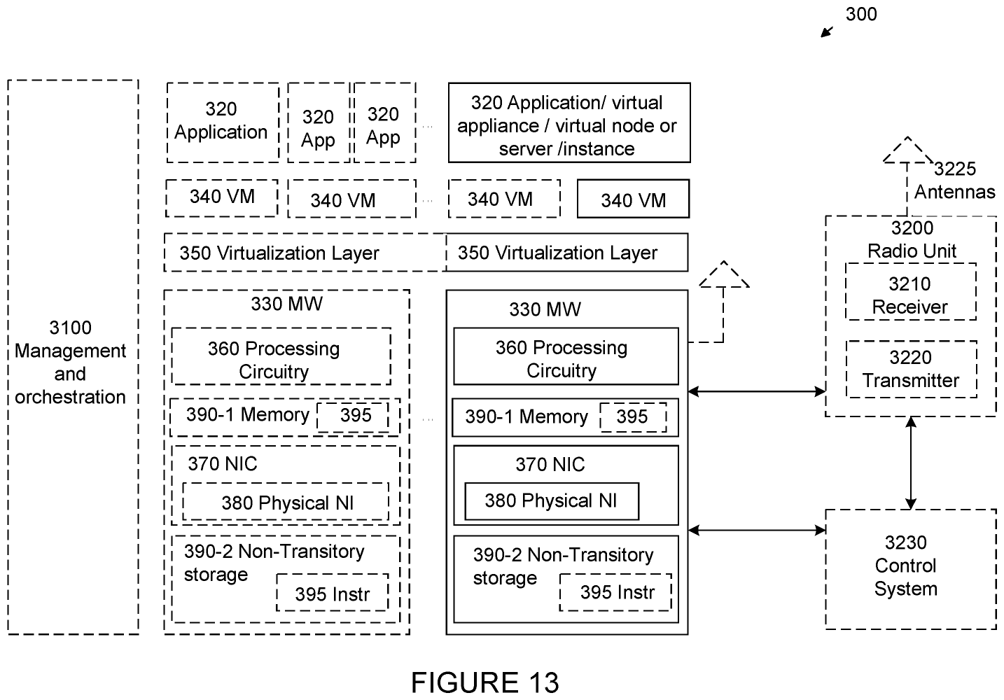

FIG. 13 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 13, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 13.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

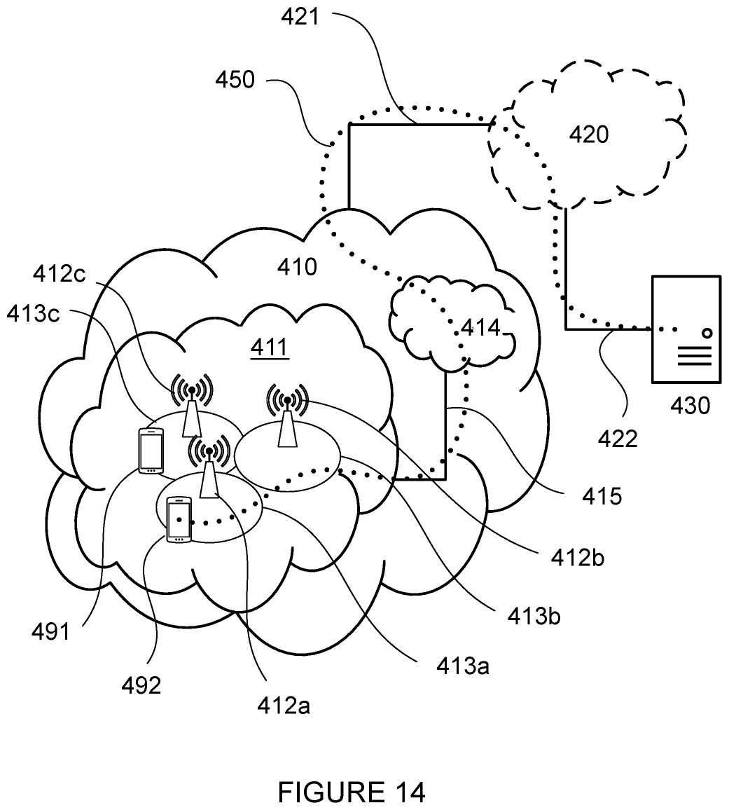

FIG. 14 illustrates a telecommunication network connected via an intermediate network to a host computer in accordance with some embodiments.

With reference to FIG. 14, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of UL and DL communications. For example, base station 412 may not or need not be informed about the past routing of an incoming communication with data originating from host computer 430 to be forwarded (e.g., handed over) to a connected UE 491. Similarly, base station 412 need not be aware of the future routing of an outgoing UL communication originating from the UE 491 towards the host computer 430.

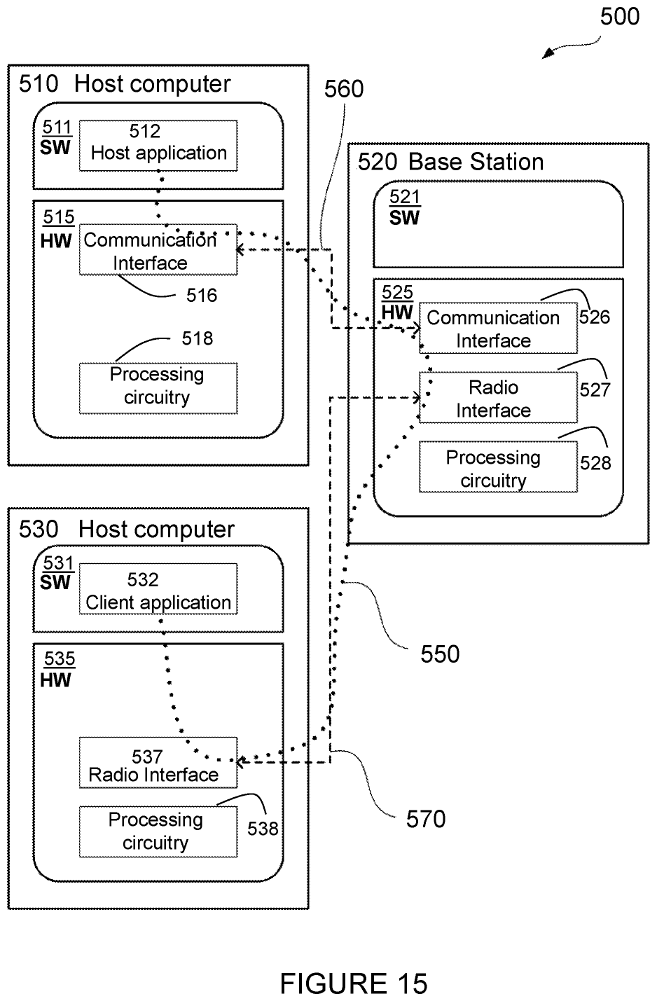

FIG. 15 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by base station 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 15 may be similar or identical to host computer 430, one of base stations 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

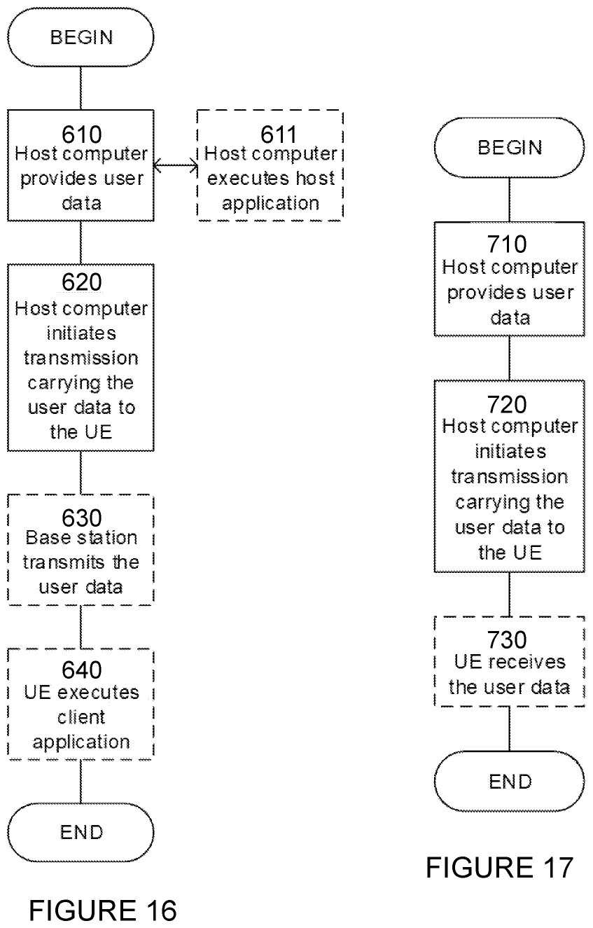

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

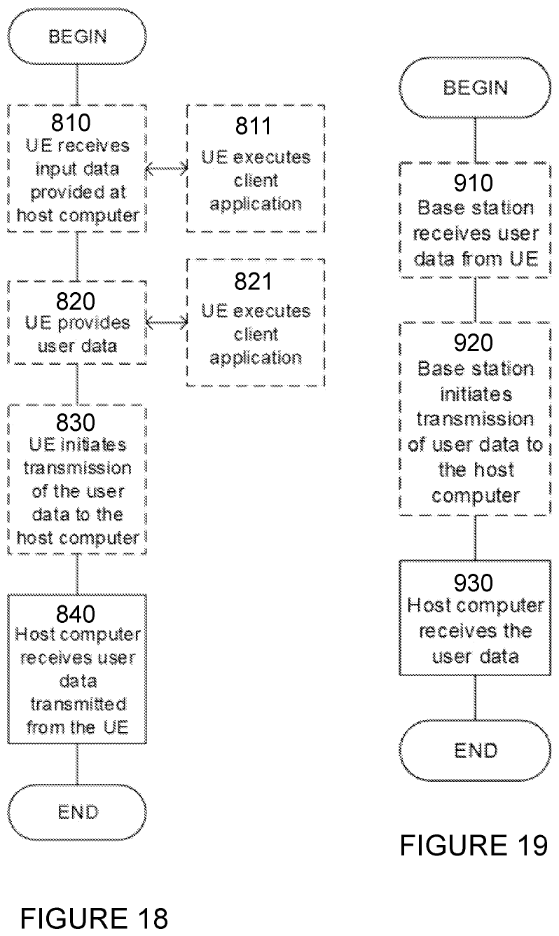

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

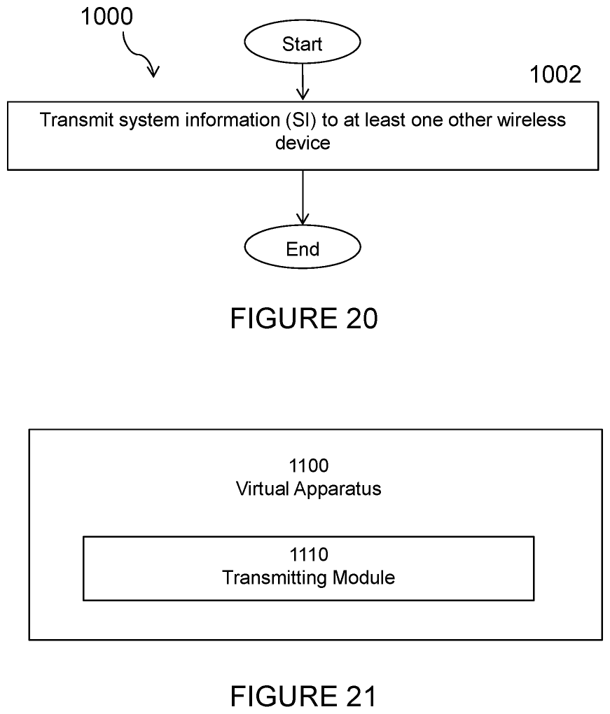

FIG. 20 depicts an example method 1000 by a wireless device 110, according to certain embodiments. At step 1002, the wireless device 110 transmits, to at least one other wireless device, SI to the at least one other wireless device.

In a particular embodiment, the SI is transmitted to the at least one other wireless device before a SL is setup between the wireless device and the at least one other wireless device.

In a particular embodiment, the SI is transmitted to the at least one other wireless device after a SL is setup between the wireless device and the at least one other wireless device.

In a particular embodiment, the at least one SL comprises a PC5-RRC connection.

In a particular embodiment, the wireless device is cable of SL relay.

In a particular embodiment, the wireless device is a relay UE.

In a particular embodiment, the at least one other wireless device is OOC.

In a particular embodiment, the wireless device receives, from a network node, a message providing information associated with the SI.

In a particular embodiment, the information comprises at least one of: at least one indicator indicating that the SI is allowed to be forwarded to the at least one other wireless device; at least one indicator indicating that the SI is allowed to be forwarded to the at least one other wireless device before a SL is setup for the at least one other wireless device; and at least one indicator indicating that the SI is allowed to be forward to the at least one other wireless device after a SL connection is setup for the at least one other wireless device.

In a particular embodiment, the at least one indicator comprises at least one of: a Boolean field, a one-bit indicator, or a text string.

In a particular embodiment, the at least one indicator comprises a plurality of indicators, each one of the plurality of indicators being associated with a particular type of SI and/or a particular group of SI that is to be forwarded to the at least one other wireless device.

In a particular embodiment, the information indicates whether a full SIB or whether only a portion of the SIB is to be transmitted to the at least one other wireless device.

In a particular embodiment, the information indicates whether the SI is to be delivered by at least one of unicast, broadcast, and/or groupcast.

In a particular embodiment, the information indicates at least one condition that must be fulfilled before the SI is transmitted to the at least one other wireless device, wherein the at least one condition is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

In a particular embodiment, the message comprises a configuration message.

In a particular embodiment, the configuration message comprises a configuration identifier.

In a particular embodiment, the information indicates at least one characteristic associated with at least one of: an access category, a Quality of Service, a UE location, and a RAN area, and wherein the SI is associated with the at least one characteristic.

In a particular embodiment, the information comprises the SI.

In a particular embodiment, the message is received at least one of: RRC signaling; a MAC Control Element; and Layer 1 (L1) signaling.

In a particular embodiment, the wireless device receives a discovery message from the at least one other wireless device, the SI information being transmitted in response to the discovery message.

In a particular embodiment, the SI information is transmitted as a broadcast and/or groupcast message.

In a particular embodiment, the at least one other wireless device comprises a remote UE.

In a particular embodiment, the wireless device determines that at least one trigger condition has been fulfilled, and wherein the SI is transmitted to the at least one other wireless device in response to determining that the at least one trigger condition has been fulfilled.

In a particular embodiment, the at least one trigger condition is fulfilled when at least one of: at least one discovery message is received; a battery percentage of the at least one other wireless device is below a predefined threshold; a particular service and/or a particular traffic type is supported by the at least one other wireless device; only a particular service and/or only a particular traffic type is supported by the at least one other wireless device; an message is received from a network node, the message indicating the at least one other wireless device; and a quality of service requirement is required by the at least one other wireless device.

In a particular embodiment, the SI comprises a SIB.

In a particular embodiment, the SI is transmitted to the at least one other wireless device via at least one of: RRC signaling; SL signaling; discovery signaling; a MAC CE; and L1 signaling.

In a particular embodiment, the wireless device comprises a UE.

In various particular embodiments, the method may additionally or alternatively include one or more of the steps or features of the Group A, Group C. and Group E Example Embodiments described below.

FIG. 21 illustrates a schematic block diagram of a virtual apparatus 1100 in a wireless network (for example, the wireless network shown in FIG. 9). The apparatus may be implemented in a wireless device or network node (e.g., wireless device 110 or network node 160 shown in FIG. 9). Apparatus 1100 is operable to carry out the example method described with reference to FIG. 20 and possibly any other processes or methods disclosed herein. It is also to be understood that the method of FIG. 20 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1110 and any other suitable units of apparatus 1100 to perform corresponding functions according one or more embodiments of the present disclosure.

According to certain embodiments, transmitting module 1110 may perform certain of the transmitting functions of the apparatus 1100. For example, transmitting module 1110 may transmit, to at least one other wireless device, system information (SI) to the at least one other wireless device.

Optionally, in particular embodiments, virtual apparatus may additionally include one or more modules for performing any of the steps or providing any of the features in the Group A, Group C, and Group E Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

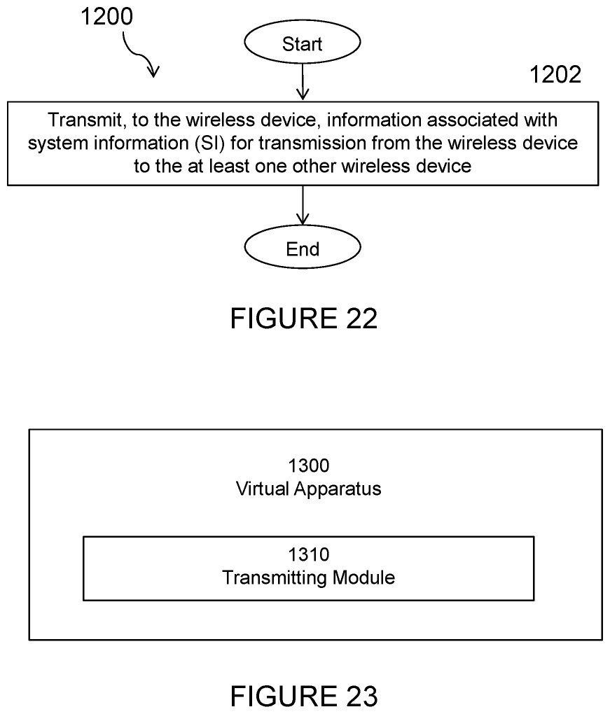

FIG. 22 depicts an example method 1200 by a network node 160 in communication with a wireless device 110 that operates as a relay for at least one additional wireless device, according to certain embodiments. At step 1202, the network node transmits, to the wireless device, information associated with SI for transmission from the wireless device to the at least one other wireless device.

In a particular embodiment, the network node configures the wireless device to transmit the SI to the at least one other wireless device before a SL is setup between the wireless device and the at least one other wireless device.

In a particular embodiment, the network node configures the wireless device to transmit the SI to the at least one other wireless device after a SL is setup between the wireless device and the at least one other wireless device.

In a particular embodiment, the at least one SL comprises a PC5-RRC connection.

In a particular embodiment, the wireless device is cable of SL relay.

In a particular embodiment, the wireless device is a relay UE.

In a particular embodiment, the at least one other wireless device is OOC.

In a particular embodiment, the information comprises at least one of: at least one indicator indicating that the SI is allowed to be transmitted by the wireless device to the at least one other wireless device; at least one indicator indicating that the SI is allowed to be transmitted by the wireless device to the at least one other wireless device before a SL is setup for the at least one other wireless device; and at least one indicator indicating that the SI is allowed to be transmitted by the wireless device to the at least one other wireless device after a SL connection is setup for the at least one other wireless device.

In a particular embodiment, the at least one indicator comprises at least one of: a Boolean field, a one-bit indicator, or a text string.

In a particular embodiment, the at least one indicator comprises a plurality of indicators, each one of the plurality of indicators being associated with a particular type of SI and/or a particular group of SI that is to be forwarded to the at least one other wireless device.

In a particular embodiment, the information indicates whether a full SIB or whether only a portion of the SIB is to be transmitted to the at least one other wireless device.

In a particular embodiment, the information indicates whether the SI is to be delivered by at least one of unicast, broadcast, and/or groupcast.

In a particular embodiment, the information indicates at least one condition that must be fulfilled before the SI is transmitted to the at least one other wireless device, wherein the at least one condition is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

In a particular embodiment, the information is transmitted in a configuration message.

In a particular embodiment, the configuration message comprises a configuration identifier.

In a particular embodiment, the information indicates at least one characteristic associated with at least one of: an access category, a QoS, a UE location, and a RAN area, and wherein the SI is associated with the at least one characteristic.

In a particular embodiment, the information comprises the SI to be transmitted to the at least one other wireless device.

In a particular embodiment, the information is transmitted via at least one of: RRC signaling; a MAC Control Element; and L1 signaling.

In a particular embodiment, the network node configures the wireless device to transmit the SI as a broadcast and/or groupcast message.

In a particular embodiment, the at least one other wireless device comprises a remote UE.

In a particular embodiment, the network node configures the wireless device to determine that at least one trigger condition has been fulfilled, and configuring the wireless device to transmit the SI to the at least one other wireless device in response to determining that the at least one trigger condition has been fulfilled.

In a particular embodiment, the at least one trigger condition is fulfilled when at least one of: at least one discovery message is received; a battery percentage of the at least one other wireless device is below a predefined threshold; a particular service and/or a particular traffic type is supported by the at least one other wireless device; only a particular service and/or only a particular traffic type is supported by the at least one other wireless device; an message is received from a network node, the message indicating the at least one other wireless device; and a quality of service requirement is required by the at least one other wireless device.

In a particular embodiment, the SI comprises a SIB.

In a particular embodiment, the network node configures the wireless device to transmit the SI to the at least one other wireless device via at least one of: RRC signaling; SL signaling; discovery signaling; a MAC CE; and L1 signaling.

In a particular embodiment, the network node transmits, to the at least one other wireless device, a configuration, the configuration indicating when the at least one other wireless device is to monitor a communication channel for the SI.

In a particular embodiment, the network node comprises a gNB.

In various particular embodiments, the method may include one or more of any of the steps or features of the Group B. Group D, and Group E Example Embodiments described below.

FIG. 23 illustrates a schematic block diagram of a virtual apparatus 1300 in a wireless network (for example, the wireless network shown in FIG. 9). The apparatus may be implemented in a wireless device or network node (e.g., wireless device 110 or network node 160 shown in FIG. 9). Apparatus 1300 is operable to carry out the example method described with reference to FIG. 22 and possibly any other processes or methods disclosed herein. It is also to be understood that the method of FIG. 22 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1310 and any other suitable units of apparatus 1300 to perform corresponding functions according one or more embodiments of the present disclosure.

According to certain embodiments, transmitting module 1310 may perform certain of the transmitting functions of the apparatus 1300. For example, transmitting module 1310 may transmit, to the wireless device, information associated with SI for transmission from the wireless device to the at least one other wireless device.

Optionally, in particular embodiments, virtual apparatus may additionally include one or more modules for performing any of the steps or providing any of the features in the Group B, Group D, and Group E Example Embodiments described below.

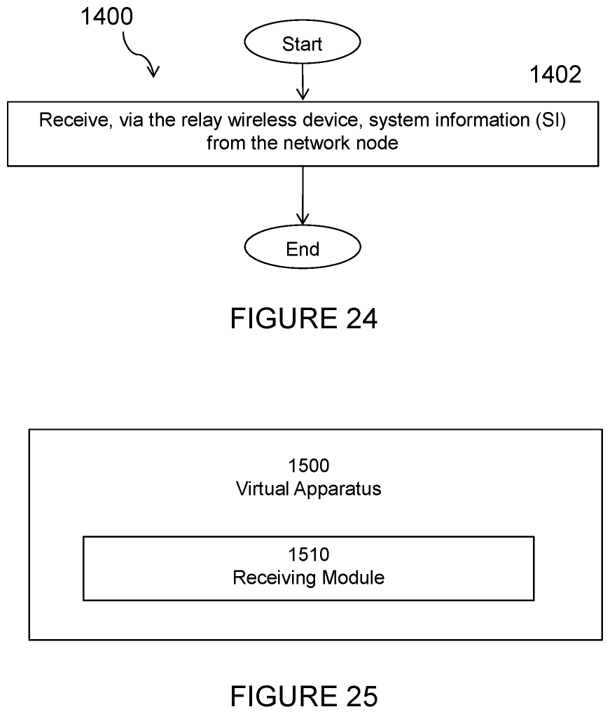

FIG. 24 depicts an example method 1400 by a wireless device 110 that operates as a remote wireless device with respect to at least one of a relay wireless device 110 and/or a network node 160, according to certain embodiments. At step 1402, the wireless device receives, via the relay wireless device, SI from the network node.

In a particular embodiment, the SI is received before a SL is setup between the wireless device and the relay wireless device.

In a particular embodiment, the SI is received after a SL is setup between the wireless device and the relay wireless device.

In a particular embodiment, the at least one SL comprises a PC5-RRC connection.

In a particular embodiment, the wireless device is OOC.

In a particular embodiment, the SI is associated with a particular type of SI and/or a particular group of SI that is forwarded to the wireless device by the relay wireless device.

In a particular embodiment, the SI comprises a full SIB.

In a particular embodiment, the SI comprises only a portion of the SIB is to be received by the wireless device.

In a particular embodiment, the SI is received by at least one of unicast, broadcast, and/or groupcast.

In a particular embodiment, the SI is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

In a particular embodiment, the wireless device transmits, to the relay wireless device, a discovery message, and wherein the SI information is received in response to the discovery message.

In a particular embodiment, the SI is received via at least one of: RRC signaling; SL signaling; discovery signaling; a MAC CE; and L1 signaling.

In a particular embodiment, the wireless device monitors, according to a configuration received from a network node and/or the relay wireless device, a communication channel for the SI.

In a particular embodiment, the configuration indicates when the wireless device is to monitor the communication channel for the SI.

In a particular embodiment, the wireless device comprises a user equipment (UE).

In various particular embodiments, the method may additionally or alternatively include one or more of the steps or features of the Group A, Group C. and Group E Example Embodiments described below.

FIG. 25 illustrates a schematic block diagram of a virtual apparatus 1500 in a wireless network (for example, the wireless network shown in FIG. 9). The apparatus may be implemented in a wireless device or network node (e.g., wireless device 110 or network node 160 shown in FIG. 9). Apparatus 1500 is operable to carry out the example method described with reference to FIG. 24 and possibly any other processes or methods disclosed herein. It is also to be understood that the method of FIG. 24 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1110 and any other suitable units of apparatus 1100 to perform corresponding functions according one or more embodiments of the present disclosure.

According to certain embodiments, transmitting module 1510 may perform certain of the receiving functions of the apparatus 1500. For example, receiving module 1510 may receive, via the relay wireless device, system information (SI) from the network node.

Optionally, in particular embodiments, virtual apparatus may additionally include one or more modules for performing any of the steps or providing any of the features in the Group A, Group C, and Group E Example Embodiments described below.

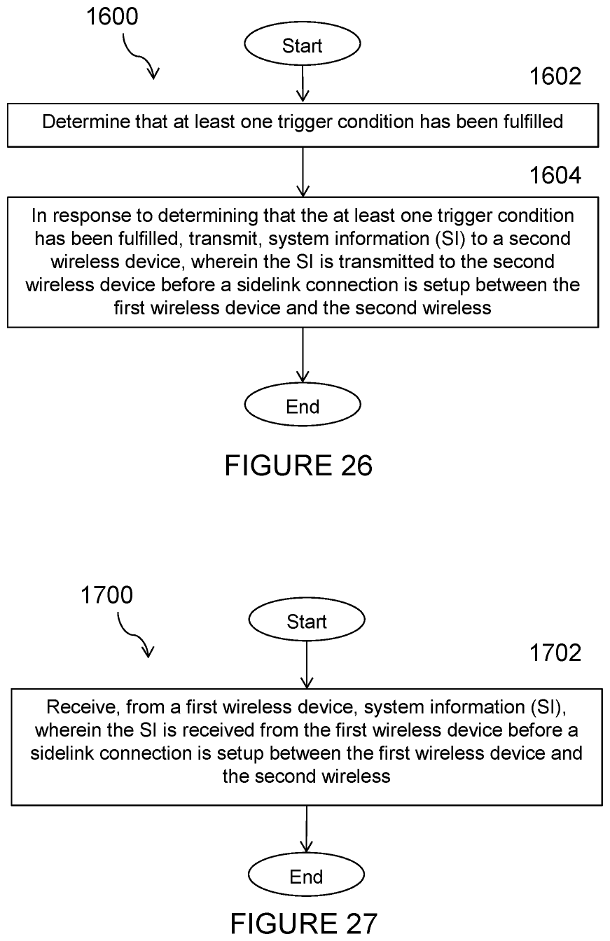

FIG. 26 illustrates an example method 1600 by a first wireless device 110, according to certain embodiments. The method begins at step 1602 when the first wireless device 110 determines that at least one trigger condition has been fulfilled. In response to determining that at least one trigger condition has been fulfilled, the first wireless device 110 transmits SI to a second wireless device, at step 1604. The SI is transmitted to the second wireless device before a SL connection is setup between the first wireless device and the second wireless device.

In a particular embodiment, the first wireless device 110 comprises a relay device between the second wireless device and at least one other device. The first wireless device 110 is configured to forward traffic to and/or from the second wireless device over the SL connection. The second wireless device comprises a remote device that receives the traffic from and/or sends the traffic to the first wireless device 110. In a further particular embodiment, the at least one other device is a gNB. In a further particular embodiment, the at least one other device is a UE.

In a particular embodiment, the SL connection comprises a PC5-RRC connection.

In a particular embodiment, the SL connection comprises a relay SL connection. As used herein, the term relay SL connection refers to a connection between the first wireless device (e.g., relay UE), the second wireless device (e.g., remote UE), and at least one other device, which may include a network node 160 or another UE or other wireless device.

In a particular embodiment, determining that the at least one trigger condition has been fulfilled includes receiving, from the second wireless device, a first message requesting to establish the SL connection.

In a particular embodiment, the first message indicates that the second wireless device is able to receive the SI before the SL connection is setup between the first wireless device 110 and the second wireless device. In a further particular embodiment, the first message is a discovery message or a Direct Communication Request (DCR) request.

In a particular embodiment, the SI is transmitted in a second message that is transmitted to the second wireless device in response to the first message, and the second message indicates that the first wireless device 110 is able to set up the SL connection.

In a particular embodiment, the first wireless device 110 transmits, to the second wireless device, a second message indicating that the first wireless device 110 is able to setup the SL, and wherein the SI is transmitted to the second wireless device before the second message is transmitted to the second wireless device.

In a further particular embodiment, the second message comprises a QoS profile that is supported by the first wireless device 110.

In a particular embodiment, the second message comprises a discovery message or a reply discovery message.

In a particular embodiment, the first message indicates a service, traffic type, or application that is requested by the second wireless device, and the step of determining that the at least one trigger condition has been fulfilled includes determining that the first wireless device 110 supports the service, traffic type, or application that is requested by the second wireless device.

In a particular embodiment, the first message comprises a Relay Service Code (RSC) that indicates the service, traffic type, or application that is requested by the second wireless device. The first wireless device 110 determines a QoS profile that is associated with the service, traffic type, or application that is requested by the second wireless device and also determines that the first wireless device 110 supports the service, traffic type, or application based on the QoS profile.

In a particular embodiment, the first message indicates a QoS profile associated with a service, traffic type, or application that is requested by the second wireless device, and the first wireless device 110 determines that the first wireless device 110 supports the service, traffic type, or application based on the QoS profile.

In a particular embodiment, when determining that the at least one trigger condition has been fulfilled, the first wireless device 110 determines that a battery percentage of the first wireless device 110 and/or the second wireless device is above a threshold.

In a particular embodiment, when determining that the at least one trigger condition has been fulfilled, the first wireless device 110 receives, from a network node 160, an indication that the SI may be sent before the SL connection is setup between the first wireless device 110 and the second wireless device.

In a particular embodiment, the second wireless device is OOC.

In a particular embodiment, the first wireless device 110 receives, from a network node 160, a message providing information associated with the SI.

In a particular embodiment, the information indicates the at least one trigger condition that must be fulfilled before the SI is transmitted to the second wireless device.

In a particular embodiment, the SI comprises a SIB.

FIG. 27 illustrates a method 1700 by a second wireless device 110, according to certain embodiments. The method begins when the second wireless device 110 receives SI from a first wireless device. The SI is received from the first wireless device before a SL connection is setup between the first wireless device and the second wireless device.

In a particular embodiment, the first wireless device comprises a relay device between the second wireless device 110 and at least one other device, and the first wireless device configured to forward traffic to and/or from the second wireless device 110 over the SL connection. Thus, the second wireless device is a remote device (e.g., remote UE) that receives the traffic from and/or sends the traffic to the first wireless device.

In a particular embodiment, the at least one SL comprises a PC5-RRC connection.

In a particular embodiment, the SL connection comprises a relay SL connection.

In a particular embodiment, the second wireless device 110 transmits, to the first wireless device, a first message requesting to establish the SL connection. In a further particular embodiment, the first message indicates that the second wireless device is able to receive the SI before the SL connection is setup between the first wireless device and the second wireless device.

In a particular embodiment, the first message is a discovery message or a DCR request.

In a particular embodiment, the SI is received in a second message that is transmitted to the second wireless device 110 in response to the first message, and the second message indicates that the first wireless device is able to set up the SL connection.

In a particular embodiment, the second wireless device 110 receives, from the first wireless device, a second message indicating that the first wireless device is able to setup the SL, and the SI is received by the second wireless device 110 before the second message is received by the second wireless device. In a further particular embodiment, the second message comprises a QoS profile that is supported by the first wireless device. Alternatively, in a further particular embodiment, the second message comprises a discovery message or a reply discovery message.

In a particular embodiment, the first message indicates a service, traffic type, or application that is requested by the second wireless device 110.

In a particular embodiment, the first message comprises a RSC that indicates the service, traffic type, or application that is requested by the second wireless device.

In a particular embodiment, the first message indicates a QoS profile associated with a service, traffic type, or application that is requested by the second wireless device 110.

In a particular embodiment, the second wireless device 110 receives, from a network node 160, an indication that the SI may be sent before the SL connection is setup between the first wireless device and the second wireless device 110.

In a particular embodiment, the second wireless device is OOC.

In a particular embodiment, the SI comprises a SIB.

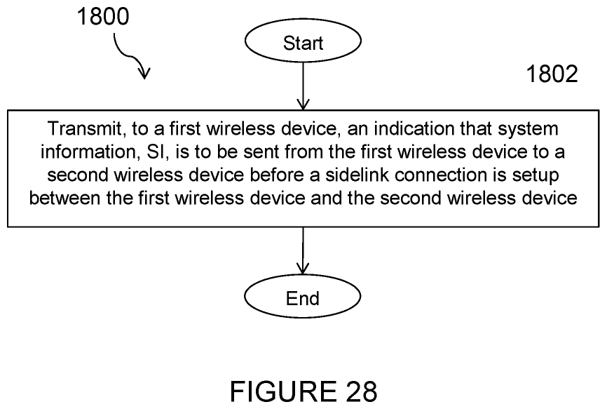

FIG. 28 illustrates an example method 1800 by a network node 160, according to certain embodiments. The method begins when network node 160 transmits, to a first wireless device 110, an indication that SI may be sent from the first wireless device 110 to a second wireless device before a SL connection is setup between the first wireless device 110 and the second wireless device.

In a particular embodiment, the first wireless device 110 comprises a relay device (e.g., relay UE) between the second wireless device and at least one other device, and the first wireless device 110 is configured to forward traffic to and/or from the second wireless device over the SL connection. Further, the second wireless device is a remote device (e.g., remote UE) that receives the traffic from and/or sends the traffic to the first wireless device 110.

In a particular embodiment, the at least one SL comprises a PC5-RRC connection.

In a particular embodiment, the first wireless device is capable of SL relay.

In a particular embodiment, the second wireless device is OOC.

### EXAMPLE EMBODIMENTS

### Group A Embodiments

Example Embodiment A1. A method by a wireless device comprising: any of the wireless device steps, features, or functions described above, either alone or in combination with other steps, features, or functions described above.

Example Embodiment A2. The method of the previous embodiment, further comprising one or more additional wireless device steps, features or functions described above.

Example Embodiment A3. The method of any of the previous embodiments, further comprising: providing user data; and forwarding the user data to a host computer via the transmission to the base station.

### Group B Embodiments

Example Embodiment B1. A method performed by a network node comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host computer or a wireless device.

### Group C Example Embodiments

Example Embodiment C1. A method by a wireless device that operates as a relay for at least one additional wireless device, the method comprising: transmitting, to at least one other wireless device, SI to the at least one other wireless device.

Example Embodiment C2. The method of Example Embodiment C1, wherein the SI is transmitted to the at least one other wireless device before a SL is setup between the wireless device and the at least one other wireless device.

Example Embodiment C3. The method of Example Embodiment C1, wherein the SI is transmitted to the at least one other wireless device after a SL is setup between the wireless device and the at least one other wireless device.

Example Embodiment C4. The method of any one of Example Embodiments C2 to C3, wherein the at least one SL comprises a PC5-RRC connection.

Example Embodiment C5. The method of any one of Example Embodiments C1 to C4, wherein the wireless device is cable of SL relay.

Example Embodiment C6. The method of any one of Example Embodiments C1 to C5, wherein the wireless device is a relay UE.

Example Embodiment C7. The method of any one of Example Embodiments C1 to C6, wherein the at least one other wireless device is OOC.

Example Embodiment C8. The method of any one of Example Embodiments C1 to C7, further comprising: receiving, from a network node, a message providing information associated with the SI.

Example Embodiment C9. The method of Example Embodiment C8, wherein the information comprises at least one of: at least one indicator indicating that the SI is allowed to be forwarded to the at least one other wireless device; at least one indicator indicating that the SI is allowed to be forwarded to the at least one other wireless device before a SL is setup for the at least one other wireless device; and at least one indicator indicating that the SI is allowed to be forward to the at least one other wireless device after a SL connection is setup for the at least one other wireless device.

Example Embodiment C10. The method of Example Embodiment C9, wherein the at least one indicator comprises at least one of: a Boolean field, a one-bit indicator, or a text string.

Example Embodiment C11. The method of any one of Example Embodiments C9 to C10, wherein the at least one indicator comprises a plurality of indicators, each one of the plurality of indicators being associated with a particular type of SI and/or a particular group of SI that is to be forwarded to the at least one other wireless device.

Example Embodiment C12. The method of any one of Example Embodiments C8 to C11, wherein the information indicates whether a full SIB or whether only a portion of the SIB is to be transmitted to the at least one other wireless device.

Example Embodiment C13. The method of any one of Example Embodiments C8 to C12, wherein the information indicates whether the SI is to be delivered by at least one of unicast, broadcast, and/or groupcast.

Example Embodiment C14. The method of any one of Example Embodiments C8 to C13, wherein the information indicates at least one condition that must be fulfilled before the SI is transmitted to the at least one other wireless device, wherein the at least one condition is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

Example Embodiment C15. The method of any one of Example Embodiments C8 to C14, wherein the message comprises a configuration message.

Example Embodiment C16. The method of Example Embodiment C15, wherein the configuration message comprises a configuration identifier.

Example Embodiment C17. The method of any one of Example Embodiments C8 to C16, wherein the information indicates at least one characteristic associated with at least one of: an access category, a Quality of Service, a UE location, and a RAN area, and wherein the SI is associated with the at least one characteristic.

Example Embodiment C18. The method of any one of Example Embodiments C8 to C17, wherein the information comprises the SI.

Example Embodiment C19. The method of any one of Example Embodiments C8 to C18, wherein the message is received at least one of: RRC signaling; a MAC CE; and L1 signaling.

Example Embodiment C20. The method of any one of Example Embodiments C1 to C19, further comprising receiving a discovery message from the at least one other wireless device, the SI information being transmitted in response to the discovery message.

Example Embodiment C21. The method of any one of Example Embodiments C1 to C20, wherein the SI information is transmitted as a broadcast and/or groupcast message.

Example Embodiment C22. The method of any one of Example Embodiments C1 to C21, wherein the at least one other wireless device comprises a remote UE.

Example Embodiment C23. The method of any one of Example Embodiments C1 to C22, further comprising determining that at least one trigger condition has been fulfilled, and wherein the SI is transmitted to the at least one other wireless device in response to determining that the at least one trigger condition has been fulfilled.

Example Embodiment C24. The method of Example Embodiment C23, wherein the at least one trigger condition is fulfilled when at least one of: at least one discovery message is received; a battery percentage of the at least one other wireless device is below a predefined threshold; a particular service and/or a particular traffic type is supported by the at least one other wireless device; only a particular service and/or only a particular traffic type is supported by the at least one other wireless device; an message is received from a network node, the message indicating the at least one other wireless device; and a quality of service requirement is required by the at least one other wireless device.

Example Embodiment C25. The method of Example Embodiments C1 to C24, wherein the SI comprises a SIB.

Example Embodiment C26. The method of Example Embodiments C1 to C25, wherein the SI is transmitted to the at least one other wireless device via at least one of: RRC signaling; SL signaling; discovery signaling; a MAC CE; and L1 signaling.

Example Embodiment C27. The method of Example Embodiments C1 to C26, wherein the wireless device comprises a UE.

Example Embodiment C28. A wireless device comprising processing circuitry configured to perform any of the methods of Example Embodiments C1 to C27.

Example Embodiment C29. A computer program comprising instructions which when executed on a computer perform any of the methods of Example Embodiments C1 to C27.

Example Embodiment C30. A computer program product comprising computer program, the computer program comprising instructions which when executed on a computer perform any of the methods of Example Embodiments C1 to C27.

Example Embodiment C31. A non-transitory computer readable medium storing instructions which when executed by a computer perform any of the methods of Example Embodiments C1 to C27.

### Group D Embodiments

Example Embodiment D1. A method by a network node in communication with a wireless device that operates as a relay for at least one additional wireless device, the method comprising: transmitting, to the wireless device, information associated with SI for transmission from the wireless device to the at least one other wireless device.

Example Embodiment D2. The method of Example Embodiment D1, further comprising configuring the wireless device to transmit the SI to the at least one other wireless device before a SL is setup between the wireless device and the at least one other wireless device.

Example Embodiment D3. The method of Example Embodiment D1 further comprising configuring the wireless device to transmit the SI to the at least one other wireless device after a SL is setup between the wireless device and the at least one other wireless device.

Example Embodiment D4. The method of any one of Example Embodiments D2 to D3, wherein the at least one SL comprises a PC5-RRC connection.

Example Embodiment D5. The method of any one of Example Embodiments D1 to D4, wherein the wireless device is cable of SL relay.

Example Embodiment D6. The method of any one of Example Embodiments D1 to D5, wherein the wireless device is a relay UE.

Example Embodiment D7. The method of any one of Example Embodiments D1 to D6, wherein the at least one other wireless device is OOC.

Example Embodiment D8. The method of any one of Example Embodiments D1 to D8, wherein the information comprises at least one of: at least one indicator indicating that the SI is allowed to be transmitted by the wireless device to the at least one other wireless device; at least one indicator indicating that the SI is allowed to be transmitted by the wireless device to the at least one other wireless device before a SL is setup for the at least one other wireless device; and at least one indicator indicating that the SI is allowed to be transmitted by the wireless device to the at least one other wireless device after a SL connection is setup for the at least one other wireless device.

Example Embodiment D9. The method of Example Embodiment D8, wherein the at least one indicator comprises at least one of: a Boolean field, a one-bit indicator, or a text string.

Example Embodiment D10. The method of any one of Example Embodiments D8 to D9, wherein the at least one indicator comprises a plurality of indicators, each one of the plurality of indicators being associated with a particular type of SI and/or a particular group of SI that is to be forwarded to the at least one other wireless device.

Example Embodiment D11. The method of any one of Example Embodiments D1 to D10, wherein the information indicates whether a full system information block (SIB) or whether only a portion of the SIB is to be transmitted to the at least one other wireless device.

Example Embodiment D12. The method of any one of Example Embodiments D1 to D11, wherein the information indicates whether the SI is to be delivered by at least one of unicast, broadcast, and/or groupcast.

Example Embodiment D13. The method of any one of Example Embodiments D1 to D12, wherein the information indicates at least one condition that must be fulfilled before the SI is transmitted to the at least one other wireless device, wherein the at least one condition is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

Example Embodiment D14. The method of any one of Example Embodiments D1 to D13, wherein the information is transmitted in a configuration message.

Example Embodiment D15. The method of Example Embodiment D14, wherein the configuration message comprises a configuration identifier.

Example Embodiment D16. The method of any one of Example Embodiments D1 to D15, wherein the information indicates at least one characteristic associated with at least one of: an access category, a Quality of Service, a UE location, and a RAN area, and wherein the SI is associated with the at least one characteristic.

Example Embodiment D17. The method of any one of Example Embodiments D1 to D16, wherein the information comprises the SI to be transmitted to the at least one other wireless device.

Example Embodiment D18. The method of any one of Example Embodiments D1 to D17, wherein the information is transmitted via at least one of: RRC signaling; a MAC CE; and L1 signaling.

Example Embodiment D19. The method of any one of Example Embodiments D1 to D18, further comprising configuring the wireless device to transmit the SI as a broadcast and/or groupcast message.

Example Embodiment D20. The method of any one of Example Embodiments D1 to D19, wherein the at least one other wireless device comprises a remote UE.

Example Embodiment D21. The method of any one of Example Embodiments D1 to D20, further comprising configuring the wireless device to determine that at least one trigger condition has been fulfilled, and configuring the wireless device to transmit the SI to the at least one other wireless device in response to determining that the at least one trigger condition has been fulfilled.

Example Embodiment D22. The method of Example Embodiment D21, wherein the at least one trigger condition is fulfilled when at least one of: at least one discovery message is received; a battery percentage of the at least one other wireless device is below a predefined threshold; a particular service and/or a particular traffic type is supported by the at least one other wireless device; only a particular service and/or only a particular traffic type is supported by the at least one other wireless device; an message is received from a network node, the message indicating the at least one other wireless device; and a quality of service requirement is required by the at least one other wireless device.

Example Embodiment D23. The method of Example Embodiments D1 to D22, wherein the SI comprises a SIB.

Example Embodiment D24. The method of Example Embodiments D1 to D23, further comprising configuring the wireless device to transmit the SI to the at least one other wireless device via at least one of: RRC signaling; SL signaling; discovery signaling; a MAC CE; and L1 signaling.

Example Embodiment D25. The method of any one of Example Embodiments D1 to D24, further comprising transmitting, to the at least one other wireless device, a configuration, the configuration indicating when the at least one other wireless device is to monitor a communication channel for the SI.

Example Embodiment D25. The method of any one of Example Embodiments D1 to D25, wherein the network node comprises a gNB.

Example Embodiment D27. A network node comprising processing circuitry configured to perform any of the methods of Example Embodiments D1 to D26.

Example Embodiment D28. A computer program comprising instructions which when executed on a computer perform any of the methods of Example Embodiments D1 to D26.

Example Embodiment D29. A computer program product comprising computer program, the computer program comprising instructions which when executed on a computer perform any of the methods of Example Embodiments D1 to D26.

Example Embodiment D30. A non-transitory computer readable medium storing instructions which when executed by a computer perform any of the methods of Example Embodiments D1 to D26.

### Group E Example Embodiments

Example Embodiment E1. A method by a wireless device that operates as a remote wireless device with respect to at least one of a relay wireless device and/or a network node, the method comprising: receiving, via the relay wireless device, SI from the network node.

Example Embodiment E2. The method of Example Embodiment E1, wherein the SI is received before a SL is setup between the wireless device and the relay wireless device.

Example Embodiment E3. The method of Example Embodiment E1, wherein the SI is received after a SL is setup between the wireless device and the relay wireless device.

Example Embodiment E4. The method of any one of Example Embodiments E2 to E3, wherein the at least one SL comprises a PC5-RRC connection.

Example Embodiment E5. The method of any one of Example Embodiments E1 to E4, wherein the wireless device is OOC.

Example Embodiment E6. The method of any one of Example Embodiments E1 to E5, wherein the SI is associated with a particular type of SI and/or a particular group of SI that is forwarded to the wireless device by the relay wireless device.

Example Embodiment E7. The method of any one of Example Embodiments E1 to E6, wherein the SI comprises a full SIB.

Example Embodiment E8. The method of any one of Example Embodiments E1 to E7, wherein the SI comprises only a portion of the SIB is to be received by the wireless device.

Example Embodiment E9. The method of any one of Example Embodiments E1 to E8, wherein the SI is received by at least one of unicast, broadcast, and/or groupcast.

Example Embodiment E10. The method of any one of Example Embodiments E1 to E9, wherein the SI is associated with: at least one access category; a QoS traffic or QoS requirement; a service that is supported by the at least one other wireless device; a geographical location of the at least one other wireless device; a RAN area; a tracking area; and a threshold associated with a RSRP, a RSRQ, and/or a SINR of the at least one other wireless device.

Example Embodiment E11. The method of any one of Example Embodiments E1 to E10, further comprising transmitting, to the relay wireless device, a discovery message, and wherein the SI information is received in response to the discovery message.

Example Embodiment E12. The method of Example Embodiments E1 to E11, wherein the SI is received via at least one of: RRC signaling; SL signaling; discovery signaling; MAC CE; and L1 signaling.

Example Embodiment E13. The method of any one of Example Embodiments E1 to E12, further comprising monitoring, according to a configuration received from a network node and/or the relay wireless device, a communication channel for the SI.

Example Embodiment E14. The method of Example Embodiment E13, wherein the configuration indicates when the wireless device is to monitor the communication channel for the SI.

Example Embodiment E15. The method of Example Embodiments E1 to C14, wherein the wireless device comprises a UE.

Example Embodiment E16. A wireless device comprising processing circuitry configured to perform any of the methods of Example Embodiments E1 to E15.

Example Embodiment E17. A computer program comprising instructions which when executed on a computer perform any of the methods of Example Embodiments E1 to E15.

Example Embodiment E18. A computer program product comprising computer program, the computer program comprising instructions which when executed on a computer perform any of the methods of Example Embodiments E1 to E15.

Example Embodiment E19. A non-transitory computer readable medium storing instructions which when executed by a computer perform any of the methods of Example Embodiments E1 to E15.

### Group F Example Embodiments

Example Embodiment F1. A wireless device comprising: processing circuitry configured to perform any of the steps of any of the Group A, Group C, and Group E Example Embodiments; and power supply circuitry configured to supply power to the wireless device.

Example Embodiment F2. A network node comprising: processing circuitry configured to perform any of the steps of any of the Group B and Group D Example Embodiments; power supply circuitry configured to supply power to the wireless device.

Example Embodiment F3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, Group C, and Group E Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment F4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B and Group D Example Embodiments.

Example Embodiment F5. The communication system of the pervious embodiment further including the network node.

Example Embodiment F6. The communication system of the previous 2 embodiments, further including the wireless device, wherein the wireless device is configured to communicate with the network node.

Example Embodiment F7. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment F8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B and Group D Example Embodiments.

Example Embodiment F9. The method of the previous embodiment, further comprising, at the network node, transmitting the user data.

Example Embodiment F10. The method of the previous 2 embodiments, wherein the user data is provided at the host computer by executing a host application, the method further comprising, at the wireless device, executing a client application associated with the host application.

Example Embodiment F11. A wireless device configured to communicate with a network node, the wireless device comprising a radio interface and processing circuitry configured to performs the of the previous 3 embodiments.

Example Embodiment F12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A, Group C, and Group E Example Embodiments.

Example Embodiment F13. The communication system of the previous embodiment, wherein the cellular network further includes a network node configured to communicate with the wireless device.

Example Embodiment F14. The communication system of the previous 2 embodiments, wherein: the processing circuitry of the host computer is configured to execute a host application, thereby providing the user data; and the wireless device's processing circuitry is configured to execute a client application associated with the host application.

Example Embodiment F15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A, Group C, and Group E Example Embodiments.

Example Embodiment F16. The method of the previous embodiment, further comprising at the wireless device, receiving the user data from the network node.

Example Embodiment F17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A, Group C, and Group E Example Embodiments.

Example Embodiment F18. The communication system of the previous embodiment, further including the wireless device.

Example Embodiment F19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment F20. The communication system of the previous 3 embodiments, wherein: the processing circuitry of the host computer is configured to execute a host application; and the wireless device's processing circuitry is configured to execute a client application associated with the host application, thereby providing the user data.

Example Embodiment F21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment F22. A method implemented in a communication system including a host computer, a network node and a wireless device, the method comprising: at the host computer, receiving user data transmitted to the network node from the wireless device, wherein the wireless device performs any of the steps of any of the Group A, Group C, and Group E Example Embodiments.

Example Embodiment F23. The method of the previous embodiment, further comprising, at the wireless device, providing the user data to the network node.

Example Embodiment F24. The method of the previous 2 embodiments, further comprising: at the wireless device, executing a client application, thereby providing the user data to be transmitted; and at the host computer, executing a host application associated with the client application.

Example Embodiment F25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment F26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B and Group D Example Embodiments.

Example Embodiment F27. The communication system of the previous embodiment further including the network node.

Example Embodiment F28. The communication system of the previous 2 embodiments, further including the wireless device, wherein the wireless device is configured to communicate with the network node.

Example Embodiment F29. The communication system of the previous 3 embodiments, wherein: the processing circuitry of the host computer is configured to execute a host application; the wireless device is configured to execute a client application associated with the host application, thereby providing the user data to be received by the host computer.

Example Embodiment F30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A, Group C, and Group E Example Embodiments.

Example Embodiment F31. The method of the previous embodiment, further comprising at the network node receiving the user data from the wireless device.

Example Embodiment F32. The method of the previous 2 embodiments, further comprising at the network node, initiating a transmission of the received user data to the host computer.

Example Embodiment F33. The method of any of the previous embodiments, wherein the network node comprises a base station.

Example Embodiment F34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a first wireless device, the method comprising:
determining that at least one trigger condition has been fulfilled; and
in response to determining that at least one trigger condition has been fulfilled, transmitting system information, SI, to a second wireless device,
wherein the SI is transmitted to the second wireless device before a sidelink, SL, connection is setup between the first wireless device and the second wireless device.

2. The method of claim 1, wherein:
the first wireless device comprises a relay device between the second wireless device and at least one other device, the first wireless device configured to forward traffic to and/or from the second wireless device over the SL connection, and
the second wireless device comprises a remote device that receives the traffic from and/or sends the traffic to the first wireless device.

3. The method of claim 1, wherein the SL connection comprises a PC5-Radio Resource Control connection.

4. The method of claim 1, wherein the SL connection comprises a relay SL connection.

5. The method of claim 1, wherein determining that the at least one trigger condition has been fulfilled comprises:
receiving, from the second wireless device, a first message requesting to establish the SL connection.

6. The method of claim 5, wherein the first message indicates that the second wireless device is able to receive the SI before the SL connection is setup between the first wireless device and the second wireless device.

7. The method of claim 5, wherein the first message is a discovery message or a Direct Communication Request, DCR, request.

8. The method of claim 5, wherein:
the SI is transmitted in a second message that is transmitted to the second wireless device in response to the first message, and
the second message indicates that the first wireless device is able to set up the SL connection.

9. The method of claim 5, further comprising transmitting, to the second wireless device, a second message indicating that the first wireless device is able to setup the SL, and wherein the SI is transmitted to the second wireless device before the second message is transmitted to the second wireless device.

10. The method of claim 8, wherein the second message comprises a Quality of Service, QoS, profile that is supported by the first wireless device.

11. The method of claim 8, wherein the second message comprises a discovery message or a reply discovery message.

12. The method of claim 5, wherein the first message indicates a service, traffic type, or application that is requested by the second wireless device, and wherein determining that the at least one trigger condition has been fulfilled further comprises:
determining that the first wireless device supports the service, traffic type, or application that is requested by the second wireless device.

13. The method of claim 12, wherein:
the first message comprises a Relay Service Code, RSC, that indicates the service, traffic type, or application that is requested by the second wireless device, and
the method further comprises:
determining, by the first wireless device, a Quality of Service, QoS, profile, that is associated with the service, traffic type, or application that is requested by the second wireless device, and
determining that the first wireless device supports the service, traffic type, or application based on the QoS profile.

14. The method of claim 12, wherein:
the first message indicates a Quality of Service, QoS, profile associated with a service, traffic type, or application that is requested by the second wireless device, and
the method further comprises determining that the first wireless device supports the service, traffic type, or application based on the QoS profile.

15. The method of claim 1, wherein determining that the at least one trigger condition has been fulfilled comprises:
determining that a battery percentage of the first wireless device and/or the second wireless device is above a threshold.

16. The method of claim 1, wherein determining that the at least one trigger condition has been fulfilled comprises:
receiving, from a network node, an indication that the SI may be sent before the SL connection is setup between the first wireless device and the second wireless device.

17. The method of claim 1, wherein the second wireless device is out-of-coverage, OOC.

18. The method of claim 1, further comprising:
receiving, from a network node, a message providing information associated with the SI.

19. The method of claim 18, wherein the information indicates the at least one trigger condition that must be fulfilled before the SI is transmitted to the second wireless device.

20. The method of claim 1, wherein the SI comprises a System Information Block, SIB.

21. A method by a second wireless device, the method comprising:
receiving, from a first wireless device, system information, SI, and
wherein the SI is received from the first wireless device before a sidelink, SL, connection is setup between the first wireless device and the second wireless device.

22.-37. (canceled)

38. A method by a network node, the method comprising:
transmitting, to a first wireless device, an indication that system information, SI, may be sent from the first wireless device to a second wireless device before a SL connection is setup between the first wireless device and the second wireless device.

39. The method of claim 38, wherein:
the first wireless device comprises a relay device between the second wireless device and at least one other device, the first wireless device configured to forward traffic to and/or from the second wireless device over the SL connection, and
the second wireless device comprises a remote device that receives the traffic from and/or sends the traffic to the first wireless device.

40. The method of claim 38, wherein the at least one SL comprises a PC5-Radio Resource Control, PC5-RRC, connection.

41. The method of claim 48, wherein the wireless device is capable of SL relay.

42. The method of claim 38, wherein the second wireless device is out-of-coverage, OOC.

43.-48. (canceled)
